(19) United States
(12) Patent Application Publication
(10) Pub. No.: US 2024/0265304 A1
(43) Pub. Date: Aug. 8, 2024

(54) OPTIMIZED LATENT MISSING FEATURE DETECTION FOR MACHINE LEARNING MODELS

(71) Applicant: Optum, Inc., Minnetonka, MN (US)

(72) Inventors: Dominik Roman Christian DAHLEM, Dublin (IE); Eran HALPERIN, Santa Monica, CA (US); James ZOU, Palo Alto, CA (US); Kevin WU, Stanford, CA (US)

(21) Appl. No.: 18/336,538

(22) Filed: Jun. 16, 2023

Related U.S. Application Data
(60) Provisional application No. 63/482,810, filed on Feb. 2, 2023.

(51) Int. Cl. G06N 20/00

(52) U.S. Cl. CPC G06N 20/00

(57) ABSTRACT

Various embodiments of the present disclosure provide techniques for optimally augmenting a training dataset for a machine learning model based on multiple model-focused predictions. The techniques may include generating a datapoint priority matrix that corresponds to a plurality of entity-feature value pairs of a training dataset for a machine learning model, generating a plurality of impact predictions and feature sensitivity predictions for the plurality of entity-feature value pairs, generating a refined datapoint priority matrix by updating the datapoint priority matrix based on the plurality of impact predictions and sensitivity predictions, and providing a datapoint collection output for the training dataset based on the refined datapoint priority matrix and a data augmentation threshold.

### CROSS-REFERENCE TO RELATED APPLICATIONS

This application claims the benefit of U.S. Provisional Application No. 63/482,810, entitled “BUDGET-CONSTRAINED APPROACH FOR DISCOVERING LATENT MISSING FEATURES DURING DEPLOYMENT,” and filed Feb. 2, 2023, the entire contents of which are hereby incorporated by reference.

### BACKGROUND

Various embodiments of the present disclosure address technical challenges related to the detection of latent missing features given limitations of existing computer data augmentation and detection techniques for machine learning models. Machine learning models may be trained using training datasets with a number of entities and various features for each entity. In real world scenarios, some features for certain entities may be unknown which may lead to degraded machine learning model performance including increased model bias towards and/or against entities with less known features. Traditionally, model performance has been improved by expending resources to conduct comprehensive data collection operations for various features of a training dataset. However, this is time consuming, expensive, and impractical for large, diverse, training datasets. Moreover, all features are not created equal. Thus, if unguided, comprehensive data augmentation techniques may expend computing resources targeting redundant features that ultimately have minimal impact on model performance. Other conventional techniques for improving training data for a machine learning model include synthetic data augmentation techniques that simulate features to replace missing features of a training dataset. While less expensive, such techniques may be less accurate than real world data and may fail to accurately capture real world characteristics that are necessary for training accurate machine learning models. Various embodiments of the present disclosure make important contributions to various existing data augmentation and detection techniques by addressing each of these technical challenges.

### BRIEF SUMMARY

Various embodiments of the present disclosure disclose data augmentation techniques for prioritizing which features of a training dataset to collect to maximize the model's improvement. The techniques of the present disclosure include predicting feature impacts on model performance associated with missing features in a training dataset and leveraging combinatoric optimization techniques for optimizing data collection operations for given data augmentation thresholds. In this way, some of the techniques of the present disclosure may guide the development of a training dataset for a machine learning model when missing features are suspected. The development of the training dataset may be grounded in the optimization of a model's performance, while minimizing for constraints, such as data augmentation thresholds, based on the use case. These techniques may be used in an offline or online setting to incrementally improve training datasets in a targeted manner. This, in turn, enables the incremental improvement of model performance and, ultimately, enables the generation of more granular, accurate, and refined, predictive insights based on real world data.

In some embodiments, a computer-implemented method includes generating, by one or more processors, a datapoint priority matrix that corresponds to a plurality of entity-feature value pairs of a training dataset for a machine learning model; generating, by the one or more processors, a plurality of impact predictions for the plurality of entity-feature value pairs, wherein an impact prediction of the plurality of impact predictions is indicative of a likelihood of a modification to an entity-feature value pair of the plurality of entity-feature value pairs through one or more data collection operations; generating, by the one or more processors, a plurality of feature sensitivity predictions for the plurality of entity-feature value pairs, wherein a feature sensitivity prediction of the plurality of feature sensitivity predictions is indicative of a feature-level performance impact of the entity-feature value pair on the machine learning model; generating, by the one or more processors, a refined datapoint priority matrix by updating the datapoint priority matrix based on the plurality of impact predictions and the plurality of sensitivity predictions; and providing, by the one or more processors, a datapoint collection output for the training dataset based on the refined datapoint priority matrix and a data augmentation threshold, wherein the datapoint collection output is indicative of a data collection operation of the one or more data collection operations.

In some embodiments, a computing system includes a memory and one or more processors communicatively coupled to the memory. The one or more processors are configured to generate a datapoint priority matrix that corresponds to a plurality of entity-feature value pairs of a training dataset for a machine learning model; generate a plurality of impact predictions for the plurality of entity-feature value pairs, wherein an impact prediction of the plurality of impact predictions is indicative of a likelihood of a modification to an entity-feature value pair of the plurality of entity-feature value pairs through one or more data collection operations; generate a plurality of feature sensitivity predictions for the plurality of entity-feature value pairs, wherein a feature sensitivity prediction of the plurality of feature sensitivity predictions is indicative of a feature-level performance impact of the entity-feature value pair on the machine learning model; generate a refined datapoint priority matrix by updating the datapoint priority matrix based on the plurality of impact predictions and the plurality of sensitivity predictions; and provide a datapoint collection output for the training dataset based on the refined datapoint priority matrix and a data augmentation threshold, wherein the datapoint collection output is indicative of a data collection operation of the one or more data collection operations.

In some embodiment, one or more non-transitory computer-readable storage media include instructions that, when executed by one or more processors, cause the one or more processors to generate a datapoint priority matrix that corresponds to a plurality of entity-feature value pairs of a training dataset for a machine learning model; generate a plurality of impact predictions for the plurality of entity-feature value pairs, wherein an impact prediction of the plurality of impact predictions is indicative of a likelihood of a modification to an entity-feature value pair of the plurality of entity-feature value pairs through one or more data collection operations; generate a plurality of feature sensitivity predictions for the plurality of entity-feature value pairs, wherein a feature sensitivity prediction of the plurality of feature sensitivity predictions is indicative of a feature-level performance impact of the entity-feature value pair on the machine learning model; generate a refined datapoint priority matrix by updating the datapoint priority matrix based on the plurality of impact predictions and the plurality of sensitivity predictions; and provide a datapoint collection output for the training dataset based on the refined datapoint priority matrix and a data augmentation threshold, wherein the datapoint collection output is indicative of a data collection operation of the one or more data collection operations.

### BRIEF DESCRIPTION OF THE DRAWINGS

FIG. 1 illustrates an example computing system in accordance with one or more embodiments of the present disclosure.

FIG. 2 is a schematic diagram showing a system computing architecture in accordance with some embodiments discussed herein.

FIG. 3 provides a dataflow diagram of an optimization technique for augmenting a training dataset in accordance with some embodiments discussed herein.

FIG. 4 provides a dataflow diagram of a machine learning feature sensitivity prediction technique for interpreting feature impact on model performance in accordance with some embodiments discussed herein.

FIG. 5 is a flowchart showing an example of a process for augmenting a training dataset in accordance with some embodiments discussed herein.

FIG. 6 is a flowchart showing an example of a process for optimizing one or more data collection operations for a training dataset in accordance with some embodiments discussed herein.

### DETAILED DESCRIPTION

Various embodiments of the present disclosure are described more fully hereinafter with reference to the accompanying drawings, in which some, but not all embodiments of the present disclosure are shown. Indeed, the present disclosure may be embodied in many different forms and should not be construed as limited to the embodiments set forth herein; rather, these embodiments are provided so that the present disclosure will satisfy applicable legal requirements. The term “or” is used herein in both the alternative and conjunctive sense, unless otherwise indicated. The terms “illustrative” and “example” are used to be examples with no indication of quality level. Terms such as “computing,” “determining,” “generating,” and/or similar words are used herein interchangeably to refer to the creation, modification, or identification of data. Further, “based on,” “based at least in part on,” “based at least on,” “based upon,” and/or similar words are used herein interchangeably in an open-ended manner such that they do not necessarily indicate being based only on or based solely on the referenced element or elements unless so indicated. Like numbers refer to like elements throughout.

### I. Computer Program Products, Methods, and Computing Entities

Embodiments of the present disclosure may be implemented in various ways, including as computer program products that comprise articles of manufacture. Such computer program products may include one or more software components including, for example, software objects, methods, data structures, or the like. A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform. Another example programming language may be a higher-level programming language that may be portable across multiple architectures. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query, or search language, and/or a report writing language. In one or more example embodiments, a software component comprising instructions in one of the foregoing examples of programming languages may be executed directly by an operating system or other software component without having to be first transformed into another form. A software component may be stored as a file or other data storage construct. Software components of a similar type or functionally related may be stored together, such as in a particular directory, folder, or library. Software components may be static (e.g., pre-established, or fixed) or dynamic (e.g., created or modified at the time of execution).

A computer program product may include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media (including volatile and non-volatile media).

In some embodiments, a non-volatile computer-readable storage medium may include a floppy disk, flexible disk, hard disk, solid-state storage (SSS) (e.g., a solid-state drive (SSD), solid state card (SSC), solid state module (SSM), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In some embodiments, a volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for, or used in addition to, the computer-readable storage media described above.

As should be appreciated, various embodiments of the present disclosure may also be implemented as methods, apparatuses, systems, computing devices, computing entities, and/or the like. As such, embodiments of the present disclosure may take the form of an apparatus, system, computing device, computing entity, and/or the like executing instructions stored on a computer-readable storage medium to perform certain steps or operations. Thus, embodiments of the present disclosure may also take the form of an entirely hardware embodiment, an entirely computer program product embodiment, and/or an embodiment that comprises combination of computer program products and hardware performing certain steps or operations.

Embodiments of the present disclosure are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatuses, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some example embodiments, retrieval, loading, and/or execution may be performed in parallel such that multiple instructions are retrieved, loaded, and/or executed together. Thus, such embodiments may produce specifically configured machines performing the steps or operations specified in the block diagrams and flowchart illustrations. Accordingly, the block diagrams and flowchart illustrations support various combinations of embodiments for performing the specified instructions, operations, or steps.

### II. Example Framework

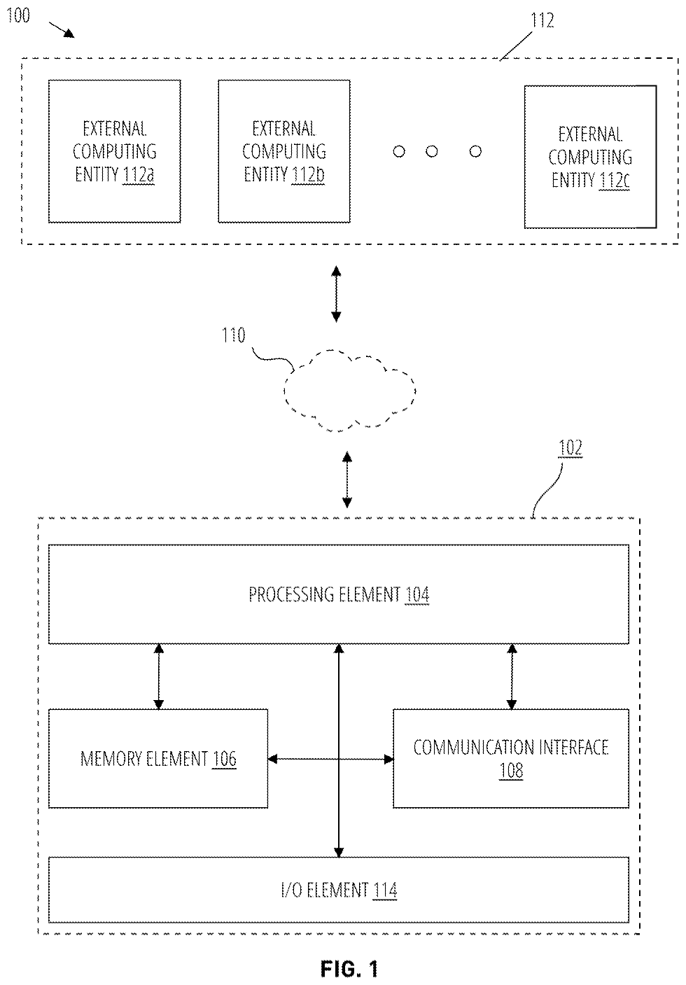

FIG. 1 illustrates an example computing system 100 in accordance with one or more embodiments of the present disclosure. The computing system 100 may include a predictive computing entity 102 and/or one or more external computing entities 112a-c communicatively coupled to the predictive computing entity 102 using one or more wired and/or wireless communication techniques. The predictive computing entity 102 may be specially configured to perform one or more steps/operations of one or more techniques described herein. In some embodiments, the predictive computing entity 102 may include and/or be in association with one or more mobile device(s), desktop computer(s), laptop(s), server(s), cloud computing platform(s), and/or the like. In some example embodiments, the predictive computing entity 102 may be configured to receive and/or transmit one or more datasets, objects, and/or the like from and/or to the external computing entities 112a-c to perform one or more steps/operations of one or more techniques (e.g., data processing techniques, predictive classification techniques, data transformation techniques, and/or the like) described herein.

The external computing entities 112a-c, for example, may include and/or be associated with one or more third parties that may be configured to receive, store, manage, and/or facilitate third-party datasets that include one or more entities and/or entity features. The external computing entities 112a-c, for example, may provide the third-party data to the predictive computing entity 102 which may leverage the third-party data to generate a training dataset. By way of example, the predictive computing entity 102 may include a data processing system that is configured to leverage data from the external computing entities 112a-c and/or one or more other data sources to train a machine learning model over a training dataset. In some examples, this may enable the aggregation of data from across the external computing entities 112a-c. The external computing entities 112a-c, for example, may be associated with one or more data repositories, cloud platforms, compute nodes, organizations, and/or the like, that may be individually and/or collectively leveraged by the predictive computing entity 102 to obtain and aggregate data regarding various entities. As one example, in a clinical prediction domain, the external computing entities 112a-c may include clinical healthcare providers that maintain electronic health records for one or more patients.

The predictive computing entity 102 may include, or be in communication with, one or more processing elements 104 (also referred to as processors, processing circuitry, digital circuitry, and/or similar terms used herein interchangeably) that communicate with other elements within the predictive computing entity 102 via a bus, for example. As will be understood, the predictive computing entity 102 may be embodied in a number of different ways. The predictive computing entity 102 may be configured for a particular use or configured to execute instructions stored in volatile or non-volatile media or otherwise accessible to the processing element 104. As such, whether configured by hardware or computer program products, or by a combination thereof, the processing element 104 may be capable of performing steps or operations according to embodiments of the present disclosure when configured accordingly.

In one embodiment, the predictive computing entity 102 may further include, or be in communication with, one or more memory elements 106. The memory element 106 may be used to store at least portions of the databases, database instances, database management systems, data, applications, programs, program modules, scripts, source code, object code, byte code, compiled code, interpreted code, machine code, executable instructions, and/or the like being executed by, for example, the processing element 104. Thus, the databases, database instances, database management systems, data, applications, programs, program modules, scripts, source code, object code, byte code, compiled code, interpreted code, machine code, executable instructions, and/or the like, may be used to control certain aspects of the operation of the predictive computing entity 102 with the assistance of the processing element 104.

As indicated, in one embodiment, the predictive computing entity 102 may also include one or more communication interfaces 108 for communicating with various computing entities, e.g., external computing entities 112a-c, such as by communicating data, content, information, and/or similar terms used herein interchangeably that may be transmitted, received, operated on, processed, displayed, stored, and/or the like.

The computing system 100 may include one or more input/output (I/O) element(s) 114 for communicating with one or more users. An I/O element 114, for example, may include one or more user interfaces for providing and/or receiving information from one or more users of the computing system 100. The I/O element 114 may include one or more tactile interfaces (e.g., keypads, touch screens, etc.), one or more audio interfaces (e.g., microphones, speakers, etc.), visual interfaces (e.g., display devices, etc.), and/or the like. The I/O element 114 may be configured to receive user input through one or more of the user interfaces from a user of the computing system 100 and provide data to a user through the user interfaces.

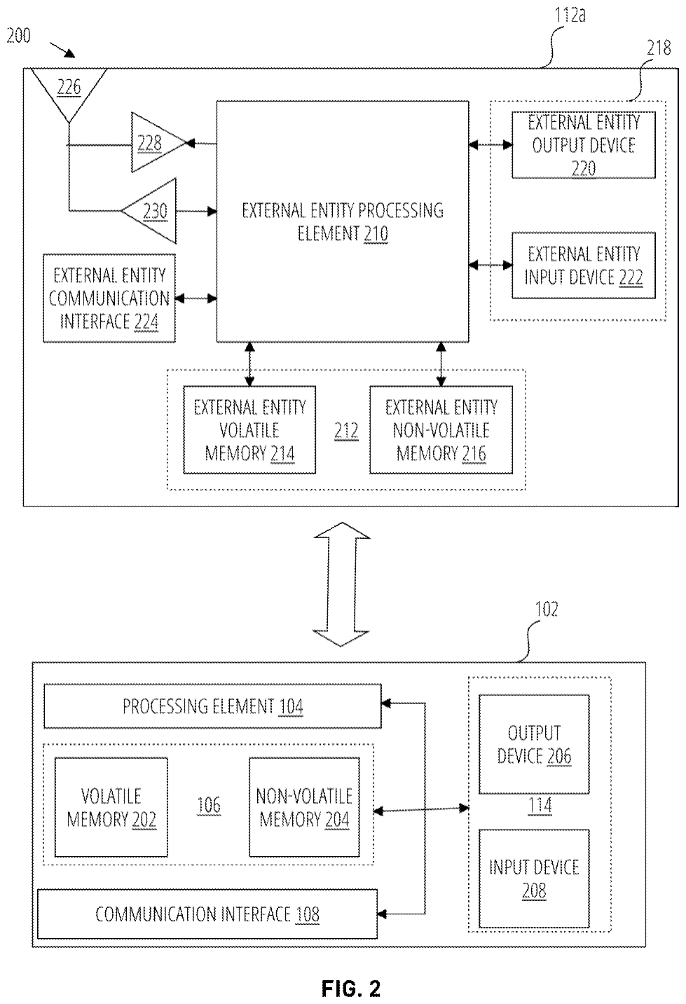

FIG. 2 is a schematic diagram showing a system computing architecture 200 in accordance with some embodiments discussed herein. In some embodiments, the system computing architecture 200 may include the predictive computing entity 102 and/or the external computing entity 112a of the computing system 100. The predictive computing entity 102 and/or the external computing entity 112a may include a computing apparatus, a computing device, and/or any form of computing entity configured to execute instructions stored on a computer-readable storage medium to perform certain steps or operations.

The predictive computing entity 102 may include a processing element 104, a memory element 106, a communication interface 108, and/or one or more I/O elements 114 that communicate within the predictive computing entity 102 via internal communication circuitry, such as a communication bus and/or the like.

The processing element 104 may be embodied as one or more complex programmable logic devices (CPLDs), microprocessors, multi-core processors, coprocessing entities, application-specific instruction-set processors (ASIPs), microcontrollers, and/or controllers. Further, the processing element 104 may be embodied as one or more other processing devices or circuitry including, for example, a processor, one or more processors, various processing devices, and/or the like. The term circuitry may refer to an entirely hardware embodiment or a combination of hardware and computer program products. Thus, the processing element 104 may be embodied as integrated circuits, application specific integrated circuits (ASICs), field programmable gate arrays (FPGAs), programmable logic arrays (PLAs), hardware accelerators, digital circuitry, and/or the like.

The memory element 106 may include volatile memory 202 and/or non-volatile memory 204. The memory element 106, for example, may include volatile memory 202 (also referred to as volatile storage media, memory storage, memory circuitry, and/or similar terms used herein interchangeably). In one embodiment, a volatile memory 202 may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for, or used in addition to, the computer-readable storage media described above.

The memory element 106 may include non-volatile memory 204 (also referred to as non-volatile storage, memory, memory storage, memory circuitry, and/or similar terms used herein interchangeably). In one embodiment, the non-volatile memory 204 may include one or more non-volatile storage or memory media, including, but not limited to, hard disks, ROM, PROM, EPROM, EEPROM, flash memory, MMCs, SD memory cards, Memory Sticks, CBRAM, PRAM, FORAM, NVRAM, MRAM, RRAM, SONOS, FJG RAM, Millipede memory, racetrack memory, and/or the like.

In one embodiment, a non-volatile memory 204 may include a floppy disk, flexible disk, hard disk, solid-state storage (SSS) (e.g., a solid-state drive (SSD)), solid state card (SSC), solid state module (SSM), enterprise flash drive, magnetic tape, or any other non-transitory magnetic medium, and/or the like. A non-volatile memory 204 may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile memory 204 may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

As will be recognized, the non-volatile memory 204 may store databases, database instances, database management systems, data, applications, programs, program modules, scripts, source code, object code, byte code, compiled code, interpreted code, machine code, executable instructions, and/or the like. The term database, database instance, database management system, and/or similar terms used herein interchangeably may refer to a collection of records or data that is stored in a computer-readable storage medium using one or more database models, such as a hierarchical database model, network model, relational model, entity-relationship model, object model, document model, semantic model, graph model, and/or the like.

The memory element 106 may include a non-transitory computer-readable storage medium for implementing one or more aspects of the present disclosure including as a computer-implemented method configured to perform one or more steps/operations described herein. For example, the non-transitory computer-readable storage medium may include instructions that when executed by a computer (e.g., processing element 104), cause the computer to perform one or more steps/operations of the present disclosure. For instance, the memory element 106 may store instructions that, when executed by the processing element 104, configure the predictive computing entity 102 to perform one or more step/operations described herein.

Embodiments of the present disclosure may be implemented in various ways, including as computer program products that comprise articles of manufacture. Such computer program products may include one or more software components including, for example, software objects, methods, data structures, or the like. A software component may be coded in any of a variety of programming languages. An illustrative programming language may be a lower-level programming language, such as an assembly language associated with a particular hardware framework and/or operating system platform. A software component comprising assembly language instructions may require conversion into executable machine code by an assembler prior to execution by the hardware framework and/or platform. Another example programming language may be a higher-level programming language that may be portable across multiple frameworks. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query, or search language, and/or a report writing language. In one or more example embodiments, a software component comprising instructions in one of the foregoing examples of programming languages may be executed directly by an operating system or other software component without having to be first transformed into another form. A software component may be stored as a file or other data storage construct. Software components of a similar type or functionally related may be stored together, such as in a particular directory, folder, or library. Software components may be static (e.g., pre-established, or fixed) or dynamic (e.g., created or modified at the time of execution).

The predictive computing entity 102 may be embodied by a computer program product include non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media such as the volatile memory 202 and/or the non-volatile memory 204.

The predictive computing entity 102 may include one or more I/O elements 114. The I/O elements 114 may include one or more output devices 206 and/or one or more input devices 208 for providing and/or receiving information with a user, respectively. The output devices 206 may include one or more sensory output devices, such as one or more tactile output devices (e.g., vibration devices such as direct current motors, and/or the like), one or more visual output devices (e.g., liquid crystal displays, and/or the like), one or more audio output devices (e.g., speakers, and/or the like), and/or the like. The input devices 208 may include one or more sensory input devices, such as one or more tactile input devices (e.g., touch sensitive displays, push buttons, and/or the like), one or more audio input devices (e.g., microphones, and/or the like), and/or the like.

In addition, or alternatively, the predictive computing entity 102 may communicate, via a communication interface 108, with one or more external computing entities such as the external computing entity 112a. The communication interface 108 may be compatible with one or more wired and/or wireless communication protocols.

For example, such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. In addition, or alternatively, the predictive computing entity 102 may be configured to communicate via wireless external communication using any of a variety of protocols, such as general packet radio service (GPRS), Universal Mobile Telecommunications System (UMTS), Code Division Multiple Access 2000 (CDMA2000), CDMA2000 1× (1×RTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.9 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol.

The external computing entity 112a may include an external entity processing element 210, an external entity memory element 212, an external entity communication interface 224, and/or one or more external entity I/O elements 218 that communicate within the external computing entity 112a via internal communication circuitry, such as a communication bus and/or the like.

The external entity processing element 210 may include one or more processing devices, processors, and/or any other device, circuitry, and/or the like described with reference to the processing element 104. The external entity memory element 212 may include one or more memory devices, media, and/or the like described with reference to the memory element 106. The external entity memory element 212, for example, may include at least one external entity volatile memory 214 and/or external entity non-volatile memory 216. The external entity communication interface 224 may include one or more wired and/or wireless communication interfaces as described with reference to communication interface 108.

In some embodiments, the external entity communication interface 224 may be supported by one or more radio circuitry. For instance, the external computing entity 112a may include an antenna 226, a transmitter 228 (e.g., radio), and/or a receiver 230 (e.g., radio).

Signals provided to and received from the transmitter 228 and the receiver 230, correspondingly, may include signaling information/data in accordance with air interface standards of applicable wireless systems. In this regard, the external computing entity 112a may be capable of operating with one or more air interface standards, communication protocols, modulation types, and access types. More particularly, the external computing entity 112a may operate in accordance with any of a number of wireless communication standards and protocols, such as those described above with regard to the predictive computing entity 102.

Via these communication standards and protocols, the external computing entity 112a may communicate with various other entities using means such as Unstructured Supplementary Service Data (USSD), Short Message Service (SMS), Multimedia Messaging Service (MMS), Dual-Tone Multi-Frequency Signaling (DTMF), and/or Subscriber Identity Module Dialer (SIM dialer). The external computing entity 112a may also download changes, add-ons, and updates, for instance, to its firmware, software (e.g., including executable instructions, applications, program modules), operating system, and/or the like.

According to one embodiment, the external computing entity 112a may include location determining embodiments, devices, modules, functionalities, and/or the like. For example, the external computing entity 112a may include outdoor positioning embodiments, such as a location module adapted to acquire, for example, latitude, longitude, altitude, geocode, course, direction, heading, speed, universal time (UTC), date, and/or various other information/data. In one embodiment, the location module may acquire data, such as ephemeris data, by identifying the number of satellites in view and the relative positions of those satellites (e.g., using global positioning systems (GPS)). The satellites may be a variety of different satellites, including Low Earth Orbit (LEO) satellite systems, Department of Defense (DOD) satellite systems, the European Union Galileo positioning systems, the Chinese Compass navigation systems, Indian Regional Navigational satellite systems, and/or the like. This data may be collected using a variety of coordinate systems, such as the Decimal Degrees (DD); Degrees, Minutes, Seconds (DMS); Universal Transverse Mercator (UTM); Universal Polar Stereographic (UPS) coordinate systems; and/or the like. Alternatively, the location information/data may be determined by triangulating a position of the external computing entity 112a in connection with a variety of other systems, including cellular towers, Wi-Fi access points, and/or the like. Similarly, the external computing entity 112a may include indoor positioning embodiments, such as a location module adapted to acquire, for example, latitude, longitude, altitude, geocode, course, direction, heading, speed, time, date, and/or various other information/data. Some of the indoor systems may use various position or location technologies including RFID tags, indoor beacons or transmitters, Wi-Fi access points, cellular towers, nearby computing devices (e.g., smartphones, laptops), and/or the like. For instance, such technologies may include the iBeacons, Gimbal proximity beacons, Bluetooth Low Energy (BLE) transmitters, NFC transmitters, and/or the like. These indoor positioning embodiments may be used in a variety of settings to determine the location of someone or something to within inches or centimeters.

The external entity I/O elements 218 may include one or more external entity output devices 220 and/or one or more external entity input devices 222 that may include one or more sensory devices described herein with reference to the I/O elements 114. In some embodiments, the external entity I/O element 218 may include a user interface (e.g., a display, speaker, and/or the like) and/or a user input interface (e.g., keypad, touch screen, microphone, and/or the like) that may be coupled to the external entity processing element 210.

For example, the user interface may be a user application, browser, and/or similar words used herein interchangeably executing on and/or accessible via the external computing entity 112a to interact with and/or cause the display, announcement, and/or the like of information/data to a user. The user input interface may include any of a number of input devices or interfaces allowing the external computing entity 112a to receive data including, as examples, a keypad (hard or soft), a touch display, voice/speech interfaces, motion interfaces, and/or any other input device. In embodiments including a keypad, the keypad may include (or cause display of) the conventional numeric (0-9) and related keys (#, *, and/or the like), and other keys used for operating the external computing entity 112a and may include a full set of alphabetic keys or set of keys that may be activated to provide a full set of alphanumeric keys. In addition to providing input, the user input interface may be used, for example, to activate or deactivate certain functions, such as screen savers, sleep modes, and/or the like.

### III. Examples of Certain Terms

In some embodiments, the term “training dataset” refers to a data entity that describes training data for a machine learning model. A training dataset may include a plurality of entities and a plurality of entity features for each of the entities. The plurality of entity features may include contextual and/or predictive features for a given machine learning model and/or predictive domain. For instance, the plurality of entities and/or entity features may be based on a predictive domain and/or a machine learning model that is trained using the training dataset. As an example, in a clinical predictive domain, an entity may include a patient and the entity features may include contextual features, such as demographic information, and/or the like, and/or predictive features, such as diagnosis information, and/or the like.

In some examples, the training dataset may include a plurality of binary features that are indicative an observation of a given event (e.g., a diagnosis code in a clinical domain, etc.). For example, the training dataset may include a matrix in which one dimension (e.g., vertical dimension, etc.) represents a plurality of entities and a second dimension (e.g., horizontal dimension, etc.) represents the occurrence of a feature for an entity. By way of example, a training dataset (e.g., before any intervention or data collection techniques, etc.) may include a matrix, X, with dimension of N*K. In some examples, N may represent a number of entities (e.g., patients in a clinical domain, etc.) in the training dataset. In some examples, K may represent a number of entity features in the training dataset. An entity-feature value may be denoted as X_{i,j}, where i is within N and ⱼ is within K. An entity-feature value, X_{i,j}, may be a “1” in the event that a particular entity Xᵢ has an observed feature, Xⱼ. Otherwise, the entity-feature value may be a “0.”

By way of example, in a clinical prediction domain, such as for a diabetes prediction model, the training dataset, X, may include a plurality of patient attributes, with N=1000, K=4 (e.g., corresponding to four features of family history, obesity, pre-diabetic status, and hypertension that are predictive of diabetes). In such a case, if a patient i has a diagnosis for hypertension, Xᵢ, hypertension=1, and if patient i does not have hypertension or hypertension has not been observed. Xᵢ, hypertension=0. In this manner, complex sequences of information may be represented by binary matrices. However, as described herein, such matrices may be misleading as an entity-feature value may be a “0” when it is either unobserved or observed and not present.

In some embodiments, the term “machine learning model” refers to a data entity that describes parameters, hyper-parameters, and/or defined operations of a rules-based and/or machine learning model (e.g., model including at least one of one or more rule-based layers, one or more layers that depend on trained parameters, coefficients, and/or the like). The machine learning model may include any type of model configured, trained, and/or the like to generate an output for a predictive and/or classification task in any predictive domain. The machine learning model may include one or more of any type of machine learning model including one or more supervised, unsupervised, semi-supervised, reinforcement learning models, and/or the like. For instance, the machine learning model may include a supervised model that may be trained using the training dataset. In some examples, the machine learning model may include multiple models configured to perform one or more different stages of a classification and/or prediction process.

In some examples, a machine learning model may be denoted as, h(⋅). The machine learning model, h(⋅), may be designed and/or trained for any purpose depending on the prediction domain. As an example, in a clinical prediction domain, the machine learning model, h(⋅), may be designed and/or trained to detect an onset of type II diabetes (T2D) using data collected through patient electronic health records (EHR). The machine learning model, h(⋅), may use four predictive features, such as family history, obesity, pre-diabetic status, and/or hypertension to generate a diabetes risk prediction for a patient. In some examples, these features may be represented by a training dataset, X. For example, each feature may be encoded as a ‘1’ if a patient meets criteria for the features or a ‘0’ if a patient either does not meet the criteria or has not received the corresponding test to observe whether the patient meets the criteria. In the event that the machine learning model is deployed to a setting of 1,000 patients who have sparse medical records, where a significant number of patients have not received a test for at least one of the four model features, the dataset may appear to contain many patients who do not have risk factors for diabetes, even though they are at the same distribution of risk as patients without missing data. In this manner, missing data within a dataset may lead to accuracy reductions for the machine learning model.

In some examples, the machine learning model, h(⋅), may be fixed and cannot be fine-tuned or trained. The machine learning model, h(⋅), may use values of X as its inputs and yields predictions of a variable of interest. Ground truth labels, y, for a variable of interest may be compared to predictions, ŷ, from the machine learning model, h(⋅), to evaluate a performance of the machine learning model, h(⋅). In some examples, the ground truth labels, y, may include a binary value and a prediction, ŷ, may be any value between 0 and 1.

In some embodiments, the term “entity-feature value pair” refers to a data value that describes a unit of a training dataset. An entity-feature value pair may be indicative of a feature value for an entity represented in a training dataset. By way of example, Xᵢⱼ may denote an entity-feature value pair that corresponds to the jth feature (e.g., family history, obesity, pre-diabetic status, and hypertension in a clinical prediction domain) for the ith entity (e.g., a patient in a clinical prediction domain). In some examples, an entity-feature value pair may be a binary value indicative of whether an entity has been observed as having a feature (e.g., a “1”) or has not been observed as having the feature (e.g., a “0”).

In some embodiments, the term “true value matrix” refers to a data structure that characterizes one or more aspects of a training dataset. For instance, the true value matrix may include one or more values that may be correlated to one or more entity-feature value pairs of the training dataset. In some examples, the true value matrix may be a matrix data structure with the same dimensions as the training dataset.

In some embodiments, the true value matrix, Z, includes a plurality of ground truth values. A ground truth value, Zᵢⱼ may be indicative of a ground truth corresponding to an entity-feature value pair. Xᵢⱼ, of the training dataset, X. The true value matrix, Z, for example, may be indicative of the true value of all features to be revealed through data collection operations. In some examples, the true values may be unknown and may only be approximated with directed and/or undirected observations (e.g., lab tests, etc. in a clinical prediction domain). The true value matrix, Z, may represent a dataset in which every potentially missing attribute is collected (observed or measured). By way of example, in a clinical predictive domain, if a patient i actually exhibits hypertension, Z_{i, hypertension}=1, and if patient i does not have hypertension, Z_{i, hypertension}=0.

In some embodiments, the term “datapoint priority matrix” refers to a data structure that characterizes one or more aspects of a training dataset. For instance, the datapoint priority matrix may include one or more values that may be correlated to one or more entity-feature value pairs of the training dataset. In some examples, the datapoint priority matrix may be a matrix data structure with the same dimensions as the training dataset.

In some embodiments, the datapoint priority matrix includes a plurality of datapoint value predictions. A datapoint value prediction may be indicative of a predictive value of performing a datapoint collection operation for an entity-feature value pair of the training dataset. By way of example, in a datapoint priority matrix, V, a datapoint value prediction, Vᵢⱼ, may be indicative of the predictive value of performing a datapoint collection operation for an entity-feature value pair, Xᵢⱼ, of the training dataset, X.

In some embodiments, the datapoint priority matrix, V, is initialized as a matrix of zeros corresponding to the entity-feature value pairs of the training dataset, X. The datapoint priority matrix may be refined, using some of the techniques of the present disclosure, by iteratively generating a datapoint value prediction for one or more of the entity-feature value pairs to generate a refined datapoint priority matrix. In some examples, each datapoint value prediction may be based on an impact prediction, a feature sensitivity prediction, and/or an entity sensitivity prediction respectively generated for a particular entity-feature value pair. In some examples, a datapoint value prediction may be generated for a subset of the entity-feature pairs based on an observation matrix.

In some embodiments, the term “observation matrix” refers to a data structure that characterizes one or more aspects of a training dataset. In some examples, the observation matrix may indicate whether a particular entity-feature value pair has been observed. For example, the observation matrix may be indicative of a subset of unobserved entity-feature values and/or a subset of observed entity-feature values from the training dataset. By way of example, an observation matrix may include a binary indicator matrix, O, which specifies whether a feature has been observed. The matrix, O, may include the same dimensions as the training dataset, X. An observation value, Oᵢⱼ, of the matrix, O, may include a “1” (e.g., an indication of an observed entity-feature value) in the event that a respective entity-feature value pair has been measured via a previous data collection operation. An observation value, Oᵢⱼ, of the matrix, O, may include a “0” (e.g., an indication of an unobserved entity-feature value) in the event that a respective entity-feature value pair has not been measured via a previous data collection operation. By way of example, in a clinical prediction domain, if patient i has been measured for hypertension (e.g., with a blood pressure cuff), O_{i, hypertension}=1 and if patient i has not been measured for hypertension, O_{i, hypertension}=0.

When combined, the observation matrix and the true value matrix may result in the training dataset. For instance, X=Z⊙O, where ⊙ is the element-wise multiplication operator. In a clinical prediction domain, for example, for hypertension to be present in the EHR (X_{i, hypertension}=1), the patient must actually be hypertensive (Z_{i, hypertension}=1) and the patient must have been measured for hypertension (O_{i, hypertension}=1). If the patient does not have hypertension (Z_{i,hypertension}=0) or has not been measured for hypertension (O_{i, hypertension}=0), hypertension will be absent from the EHR (X_{i, hypertension}=0).

In some embodiments, the term “impact prediction” refers to a data value that describes an attribute of an entity-feature value pair. For example, an impact prediction, \hat{Δ}ᵢⱼ, may include a missingness estimation that identifies a probability that an unobserved entity-feature value pair may change in response to data collection operation. The impact prediction, \hat{Δ}ᵢⱼ, for example, may include an estimate of the change in value of Xᵢⱼ after a data collection operation.

In some embodiments, the impact prediction for an entity-feature value pair is based on a predictive feature miss rate, a predictive entity miss rate, and/or a variance associated therewith. The predictive feature miss rate may be indicative of a rate at which a particular feature is detected in response to a data collection operation. For instance, the predictive feature miss rate may include an average number of detections proportional to a total number of data collection operations for a particular feature. The predictive entity miss rate may be indicative of a rate at which any feature is detected for a particular entity (and/or entity type) in response to data collection operations. For instance, the predictive entity miss rate may include an average number of detections proportional to a total number of data collection operations for a particular entity (and/or entity type). An entity type, for example, may be indicative of a cohort of entities with one or more similar attributes.

In some examples, an impact prediction, \hat{Δ}ᵢⱼ, may be the maximum number of cases in which an entity who currently lacks an observed feature is assigned the observed feature after a data collection operation. By way of example, in a clinical prediction domain, the impact prediction, \hat{Δ}ᵢⱼ, may be the maximum number of cases in which patients who currently lack a given diagnosis in their EHR could have that diagnosis added if tested. The maximum number of feature changes (e.g., diagnostic switches) from negative to positive may be equal to the number of instances in which an entity (e.g., patient) actually exhibits a feature, Zᵢⱼ=1, minus the number of instances in which the feature is reported in the medical record, Xᵢⱼ=1. In some examples, it may be assumed that there are no false positives in which an entity does not actually exhibit the feature, was tested, and received a positive test result. The impact prediction, Δᵢⱼ, may be generated using a Beta distribution and an initial “guess” of the missingness of feature j by an average feature miss rate, μⱼ, and variance, σⱼ². In a continuous learning embodiment, the feature miss rate and/or entity miss rate may be continuously updated as more data is collected according to a Beta-Binomial conjugate. In addition, or alternatively, the impact prediction \hat{Δ}ᵢⱼ may be constant and one or more other predictions, such as the feature sensitivity prediction, ϕᵢⱼ, and/or the entity sensitivity prediction, Eᵢ, may be leveraged to generate a datapoint value prediction v_{i,j}, as described herein.

As one example, in an offline setting, a subroutine for computing \hat{Δ}ᵢⱼ may include:

$${α}_{j} = ( \frac{1 - {μ}_{j}}{{σ}_{j}^{2}} - \frac{1}{{μ}_{j}} ) {μ}_{j}^{2} , {β}_{j} = {α}_{j} ( \frac{1}{{μ}_{j}} - 1 ) ∀ j ∈ [ K ]$$

$$Return {\hat{Δ}}_{i j} ∼ B e t a ( {α}_{j} , {β}_{j} )$$

In some embodiments, in the absence of domain-informed miss rates, αⱼ=βⱼ=1.

As another example, in a continuous learning setting, a subroutine for computing \hat{Δ}ᵢⱼ may include:

$$If t = 0 :$$

$${α}_{j} = ( \frac{1 - {μ}_{j}}{{σ}_{j}^{2}} - \frac{1}{{μ}_{j}} ) {μ}_{j}^{2} , {β}_{j} = {α}_{j} ( \frac{1}{{μ}_{j}} - 1 ) ∀ j ∈ [ K ]$$

$$return {\hat{Δ}}_{i j} ∼ B e t a ( {α}_{j} + {\sum }_{t} {r}_{j}^{t} , {β}_{j} + {\sum }_{t} ( 1 - {r}_{j}^{t} ) )$$

where the superscript t corresponds to a variable at time step t and the subscript r corresponds to a reward history. For example, X^{(t)} may correspond to X after t rounds of data collection operations. In addition, or alternatively, the reward history, r, may include a list of the data collected for each feature j. For example, if at time t, the jth feature has been collected for 5 entities, the reward history for j may look like [0, 1, 1, 0, 1], where a positive value is observed for the second, third, and fifth entity. If feature j is collected across 100 entities, and 30 of those entities yielded a positive value, then Δᵢⱼ˜ Beta(31, 71).

In some embodiments, the term “feature sensitivity prediction” refers to a data value that describes an attribute of an entity-feature value pair. For example, a feature sensitivity prediction, ϕᵢⱼ, may include a feature sensitivity estimation that identifies a performance impact that a feature may have on a machine learning model. The feature sensitivity prediction, ϕᵢⱼ, for example, may include an estimate of the change in the performance of the machine learning model after a data collection operation for the entity-feature pair, Xᵢⱼ.

In some examples, the feature sensitivity prediction, ϕᵢⱼ, may be indicative of an estimate of the change in a model's performance that assumes a data collection operation will change a feature value from 0 to 1. The feature sensitivity prediction may be generated using an interpretable model. In some examples, a standard Shapley values may be leveraged to approximate the value of feature changes on the predictive model outcome. However, not all feature changes matter (0 to 1, 1 to 0). To accommodate for this, a modified SHAP computation may be leveraged that only considers the feature changes from 0 to 1. For instance, a modified version of a Shapley value may be leveraged to generate a feature sensitivity prediction, ϕᵢⱼ, to estimate how the predictive performance of a model will change. Unlike traditional machine learning interpretation techniques, the feature sensitivity prediction, ϕᵢⱼ, evaluates an average marginal contribution of a feature across permutations of a subset (e.g., rather than all) of features (e.g., a subset of unobserved features) that could potentially change through one or more data collection operations. For example, a subroutine for computing ϕᵢⱼ may include:

$${ϕ}_{i j} = \frac{1}{\vert {G}_{i} \vert !} {\sum }_{S ∈ {π}_{{G}_{i} \backslash j}} [ {f}_{i} ( S ⋃ j ) - {f}_{i} ( S ) ]$$

In the equation above, Gᵢ={j:Oᵢⱼ=0} may represent a subset of unobserved features (e.g., a set of indices for all features which have not been observed) and π_{G} may be the set of all permutations of those indices. The term ƒᵢ may represent a function that maps a set of indices S to the model's prediction on a perturbed version of xᵢ where xᵢⱼ=1∀j∈S. In this manner, the feature sensitivity prediction is indicative of an average marginal change in model prediction over all permutations that xᵢ can take on over the course of one or more data collection operations.

In some embodiments, the term “interpretable model” refers to a data entity that describes parameters, hyper-parameters, and/or defined operations of a rules-based and/or machine learning model (e.g., model including at least one of one or more rule-based layers, one or more layers that depend on trained parameters, coefficients, and/or the like). The interpretable model may include any type of model configured, trained, and/or the like to interpret an output of a machine learning model. For example, the interpretable model may include one or more explainable AI methods (“xAI”) configured to explain an output of a machine learning model. In some examples, the interpretable model may include a Shapley Additive explanations algorithm (“SHAP”), explainable graph neural network (“XGNN”), Local Interpretable Model Agnostic Explanations (“LIME”), and/or the like.

In some embodiments, the term “entity sensitivity prediction” refers to a data value that describes an attribute of an entity-feature value pair. For example, an entity sensitivity prediction, Eᵢ, may include an entity sensitivity estimation that identifies a performance impact that an entity may have on a machine learning model. The entity sensitivity prediction, Eⱼ, for example, may include an estimate of the change in the performance of the machine learning model after a data collection operation for the entity-feature pairs of an Eᵢ. In some examples, the entity sensitivity prediction Eᵢ may be a constant and one or more other predictions, such as the feature sensitivity prediction, ϕᵢⱼ, and/or the impact prediction, \hat{Δ}ᵢⱼ, may be leveraged to generate a datapoint value prediction v_{i,j}, as described herein.

For example, the entity sensitive prediction may include an estimate of a machine learning model's uncertainty for a given entity, i. For entities for which the model is currently performing more poorly, the expected benefit of a data collection operation may be greater. The entity sensitive prediction may be reflected in the predictive entropy of the model on xᵢ:

$${E}_{i} = 1 - h ( {x}_{i} ) log [ h ( {x}_{i} ) ] - ( 1 - h ( {x}_{i} ) ) log [ 1 - h ( {x}_{i} ) ]$$

The predictive entropy may be maximized when the model prediction h(xᵢ)=0.5, and may be minimized when h(xᵢ)=0 or h(xᵢ)=1.

In some embodiments, the term “cost matrix” refers to a data structure that characterizes one or more aspects of a training dataset. In some examples, the cost matrix may indicate a cost associated with one or more data collection operations for a particular entity-feature value pair. For instance, the cost matrix may include one or more values that may be correlated to one or more entity-feature value pairs of the training dataset. In some examples, the cost matrix may be a matrix data structure with the same dimensions as the training dataset. In such a case, the cost matrix may indicate a cost for each entity-feature value pair of the training dataset. By way of example, the cost matrix, C, may include a matrix of cost values, where the cost value, Cᵢⱼ, may correspond to the cost of collecting the jth feature for the ith entity. In some examples, the cost may vary for each entity, feature, and/or entity-feature value pair. In addition, or alternatively, the cost may include a fixed cost for one or more entities, features, and/or entity-feature value pairs.

In some embodiments, the term “data augmentation threshold” refers to a data entity that describes a constraint for determining a set of data collection operations. The data augmentation threshold, for example, may be indicative of a limit on the one or more data collection operations. For instance, the data augmentation threshold may include a budget, B, for performing the one or more data collection operations. The data augmentation threshold, B, may include a scalar value. It may be preset, dynamically set, and/or automatically determined based on one or more data collection policies associated with the training dataset and/or machine learning model.

In some embodiments, the term “combinatoric optimization model” refers to a data entity that describes parameters, hyper-parameters, and/or defined operations of a rules-based and/or machine learning model (e.g., model including at least one of one or more rule-based layers, one or more layers that depend on trained parameters, coefficients, and/or the like). The combinatoric optimization model may include any type of model configured, trained, and/or the like to optimize a set of options based on one or more constraints, such as the data augmentation threshold. For example, the combinatoric optimization model may include a knapsack algorithm and/or any other optimization method, for determining one or more data collection operations for a training dataset.

For instance, the combinatoric optimization model may be configured to generate one or more data collection operations based on a data augmentation threshold, a list of entity-feature value pairs (e.g., from the data priority matrix, etc.), and/or one or costs (e.g., from the cost matrix). The one or more data collection operations may include operations for which the sum total value is maximized under the constraint that the sum total cost is less than the data augmentation threshold, B. For example:

$$max {\sum }_{i = 1}^{N} {\sum }_{j = 1}^{K} {V}_{ij} {O}_{ij}$$

$$subject to {\sum }_{i = 1}^{N} {\sum }_{j = 1}^{K} {C}_{ij} {O}_{ij} \leq B$$

In some examples, a 0/1 knapsack algorithm may be used to handle cases in which 0 or 1 copies of each item may be chosen. In a clinical prediction domain, using the values for \hat{Δ}ᵢⱼ, ϕᵢⱼ, and E, the 0/1 knapsack algorithm may output a list of patient-by-feature combinations (i, j) in order of decreasing predictive value (V). Each combination may be associated with the cost of testing the patient for the particular feature. The list may be truncated when the sum of the costs exceeds data augmentation threshold, B.

In some embodiments, the term “datapoint collection operation” refers to an action configured to augment a training dataset with one or more observed values. A datapoint collection operation may include a computing task and/or manual operation. By way of example, a datapoint collection operation may include computing tasks for querying previously unobserved datapoints from a data source, transforming data to generate a previously unobserved datapoint, generating and/or providing one or more instructions for initiating a data collection task, and/or the like. As other examples, the datapoint collection operation may include manual operations, such as performing one or more diagnostic actions (e.g., in a clinical prediction domain, etc.), and/or the like.

In some examples, a datapoint collection operation may correspond to an entity-feature value pair of a training dataset. For instance, a data collection operation may be configured to receive an observed value for a particular entity-feature value pair. By way of example, in a clinical prediction domain, a datapoint collection operation may include a diagnostic test (e.g., through one or more computing and/or manual operations, etc.) for diagnosing a particular feature for a patient. In some examples, a datapoint collection operation may be configured to collect a plurality of observed feature values for a plurality of different entity-feature value pairs.

In some embodiments, the term “collection feedback data” refers to an output from one or more datapoint collection operations. The collection feedback data, for example, may include a plurality of observed values for one or more entity-feature value pairs of the training dataset.

### IV. Overview, Technical Improvements, and Technical Advantages

Some embodiments of the present disclosure present predictive techniques for augmenting a training dataset to improve upon traditional data augmentation methodologies. Some of the techniques of the present disclosure address technical problems related to latent missingness in a training dataset, which refers to features for which missingness is unknown. Machine learning models may use binary features to indicate the observation of a given event (e.g., a diagnosis code appearing in patient records or a lab value over a certain level). However, it is unclear whether a negative value indicates that such events never occurred or are simply missing. Such ambiguity leads to a unique problem in the deployment of machine learning models, as usual approaches to handling missing data (e.g., dropping rows, multiple imputation) are not able to be applied. Unknown missing values may be discovered through data collection but collecting all possibly missing values is cost-prohibitive to the user and/or organization that deploys such models. Some of the techniques of the present disclosure address these technical problems by generating a plurality of model-focused predictions to predict multiple different impacts of a data collection operation on a training dataset and the ultimate performance of a machine learning model. These model-focused predictions may be leveraged to optimize the augmentation of a training dataset based on any number of constraints that may be applied to the data collection process. In this way, a data augmentation process may be implemented that is tailored to particular constraints and that optimizes computing resources by generating predictive insights for guiding the data collection process.

Some embodiments of the present disclosure present techniques for generating a predictive impact (e.g., a missingness value) of data collection operations on features of a training dataset. Some techniques of the present disclosure, for example, may generate an impact prediction that is reflective of a likelihood of a modification to an entity-feature value pair through one or more data collection operations. The impact prediction may be generated using sampling algorithms modified for the discovery of missing data. By doing so, the techniques of the present disclosure may improve data augmentation techniques by tailoring data collection operations to the values of a training dataset that may be changed if observed, thereby optimizing the allocation of computing resources based on the predictive impact of such operations.

Some embodiments of the present disclosure present techniques for predicting a feature sensitivity of a machine learning model that is tailored to missing features from a training dataset. Some techniques of the present disclosure, for example, may generate a feature sensitivity prediction that is reflective of a feature-level performance impact of an entity-feature value pair on a machine learning model. Unlike traditional techniques, the feature-level performance impact may be based on an average marginal contribution of a feature over permutation of a subset of features which could possibly change during data collection. By doing so, the techniques of the present disclosure may improve machine learning explainability techniques by tailoring feature contributions to the values of a training dataset that may be changed if observed, thereby further optimizing the allocation of computing resources based on the predictive impact of such operations.

Example inventive and technologically advantageous embodiments of the present disclosure include (i) a multi-stage prediction process for interpreting feature value based on predicted model performance, (ii) techniques for generating a predictive impact (e.g., a missingness value) of data collection operations on features of a training dataset, (iii) techniques for predicting a feature sensitivity of a machine learning model that is tailored to missing features from a training dataset, among other improvements described herein.

### V. Example System Operations

As indicated, various embodiments of the present disclosure make important technical contributions to machine learning technology. In particular, systems and methods are disclosed herein that implement prediction and data augmentation techniques for optimally augmenting a training dataset by leveraging a plurality of model-focused predictions. Unlike traditional data augmentation techniques, the techniques of the present disclosure leverage impact predictions as well as feature and/or entity sensitivity predictions for assessing the value of a particular datapoint in a training dataset.

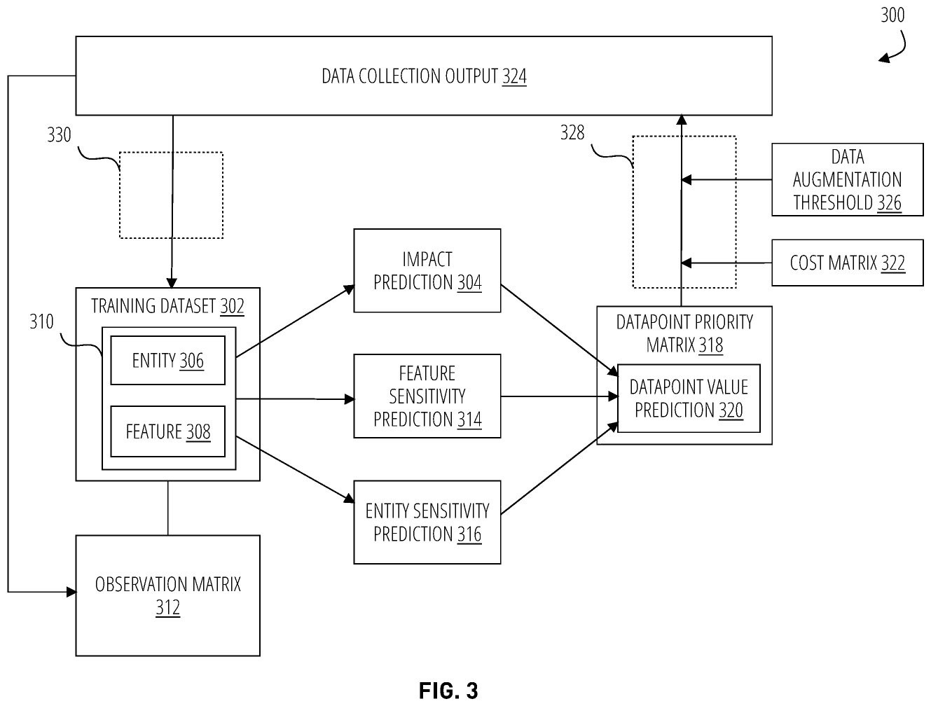

FIG. 3 provides a dataflow diagram 300 of an optimization technique for augmenting a training dataset in accordance with some embodiments discussed herein. The optimization technique leverages a plurality feature-specific predictions for interpreting the individual predictive values of various entity-feature pairs of a training dataset 302. Using this understanding as well as other data collection constraints, the optimization techniques may initiate targeted data collection operations that are tailored to a machine learning model and the training dataset 302 corresponding thereto. Such data collection operations may provide data collection outputs 324 that may be used to iteratively augment the training dataset 302 to improve model performance.

In some embodiments, the training dataset 302 is a data entity that describes training data for a machine learning model. The training dataset 302 may include a plurality of entities 306 and a plurality of entity features 308 for each of the entities 306. The plurality of entity features 308 may include contextual features and/or predictive features for a given machine learning model and/or predictive domain. For instance, the plurality of entities 306 and/or entity features 308 may be based on a predictive domain and/or a machine learning model that is trained using the training dataset 302. As an example, in a clinical predictive domain, an entity 306 may include a patient and the entity features 308 may include contextual features, such as demographic information, and/or the like, and/or predictive features, such as diagnosis information, and/or the like.

In some examples, the training dataset 302 may include a plurality of binary features that are indicative an observation of a given event (e.g., a diagnosis code in a clinical domain, etc.). For example, the training dataset 302 may include a matrix in which one dimension (e.g., vertical dimension, etc.) represents a plurality of entities 306 and a second dimension (e.g., horizontal dimension, etc.) represents the occurrence of a feature 308 for an entity 306. By way of example, the training dataset 302 (e.g., before any intervention or data collection techniques, etc.) may include a matrix. X, with dimension of N*K. In some examples, N may represent a number of entities 306 (e.g., patients in a clinical domain, etc.) in the training dataset 302. In some examples, K may represent a number of entity features 308 in the training dataset 302. An entity-feature value pair 310 may be denoted as X_{i,j}, where i is within N and ⱼ is within K. An entity-feature value 310, X_{i,j}, may be a “1” in the event that a particular entity Xᵢ has an observed feature, Xⱼ. Otherwise, the entity-feature value pair 310 may be a “0.”

By way of example, in a clinical prediction domain, such as for a diabetes prediction model, the training dataset 302, X, may include a plurality of patient attributes, with N=1000, K=4 (e.g., corresponding to four features of family history, obesity, pre-diabetic status, and hypertension that are predictive of diabetes). In such a case, if a patient i has a diagnosis for hypertension, Xᵢ, hypertension=1, and if patient i does not have hypertension or hypertension has not been observed, Xᵢ, hypertension=0. In this manner, complex sequences of information may be represented by binary matrices. As described herein, such matrices may be misleading as an entity-feature value pair 310 may be a “0” when it is either unobserved or observed and not present.

In some embodiments, the entity-feature value pair 310 is a data value that describes a unit of a training dataset 302. An entity-feature value pair 310 may be indicative of a feature value for an entity 306 represented in a training dataset 302. By way of example, Xᵢⱼ may denote an entity-feature value pair 310 that corresponds to the jth feature (e.g., family history, obesity, pre-diabetic status, and hypertension in a clinical prediction domain) for the ith entity (e.g., a patient in a clinical prediction domain). In some examples, an entity-feature value pair 310 may be a binary value indicative of whether an entity 306 has been observed as having a feature 308 (e.g., a “1”) or has not been observed as having the feature 308 (e.g., a “0”).

In some embodiments, the machine learning model is a data entity that describes parameters, hyper-parameters, and/or defined operations of a rules-based and/or machine learning model (e.g., model including at least one of one or more rule-based layers, one or more layers that depend on trained parameters, coefficients, and/or the like). The machine learning model may include any type of model configured, trained, and/or the like to generate an output for a predictive and/or classification task in any predictive domain. The machine learning model may include one or more of any type of machine learning model including one or more supervised, unsupervised, semi-supervised, reinforcement learning models, and/or the like. For instance, the machine learning model may include a supervised model that may be trained using the training dataset 302. In some examples, the machine learning model may include multiple models configured to perform one or more different stages of a classification and/or prediction process.

In some examples, a machine learning model may be denoted as, h(⋅). The machine learning model, h(⋅), may be designed and/or trained for any purpose depending on the prediction domain. As an example, in a clinical prediction domain, the machine learning model, h(⋅), may be designed and/or trained to detect an onset of type II diabetes (T2D) using data collected through patient electronic health records (EHR). The machine learning model, h(⋅), may use four predictive features, such as family history, obesity, pre-diabetic status, and/or hypertension to generate a diabetes risk prediction for a patient. In some examples, these features may be represented by a training dataset 302. X. For example, each feature may be encoded as a ‘1’ if a patient meets criteria for the features or a ‘0’ if a patient either does not meet the criteria or has not received the corresponding test to observe whether the patient meets the criteria. In the event that the machine learning model is deployed to a setting of 1,000 patients who have sparse medical records, where a significant number of patients have not received a test for at least one of the four model features, the training dataset 302 may appear to contain many patients who do not have risk factors for diabetes, even though they are at the same distribution of risk as patients without missing data. In this manner, missing data within the training dataset 302 may lead to accuracy reductions for the machine learning model.

In some examples, the machine learning model, h(⋅), may be fixed and cannot be fine-tuned or trained. The machine learning model, h(⋅), may use values of the training dataset 302, X, as its inputs and yields predictions of a variable of interest. Ground truth labels, y, for a variable of interest may be compared to predictions, ŷ, from the machine learning model, h(⋅), to evaluate a performance of the machine learning model, h(⋅). In some examples, the ground truth labels, y, may include a binary value and a prediction, ŷ, may be any value between 0 and 1.

In an optimized training dataset for the machine learning model, the training dataset 302 may include a true value matrix in which each entity-feature value pair 310 includes the true value for an entity feature.

In some embodiments, the true value matrix is a data structure that characterizes one or more aspects of a training dataset 302. For instance, the true value matrix may include one or more values that may be correlated to one or more entity-feature value pairs 310 of the training dataset 302. In some examples, the true value matrix may be a matrix data structure with the same dimensions as the training dataset.

In some embodiments, the true value matrix, Z, includes a plurality of ground truth values. A ground truth value, Zᵢⱼ may be indicative of a ground truth corresponding to an entity-feature value pair, Xᵢⱼ, of the training dataset, X. The true value matrix, Z, for example, may be indicative of the true value of all features to be revealed through data collection operations. The true value matrix, Z, may represent a dataset in which every potentially missing attribute is collected (observed or measured). By way of example, in a clinical predictive domain, if a patient i actually exhibits hypertension, Z_{i, hypertension}=1, and if patient i does not have hypertension, Z_{i, hypertension}=0.

In real world datasets, a true value matrix may be impractical due to resource constraints. In some examples, a training dataset 302 may include an observation matrix 312 indicative of which values have been observed (e.g., are true values) and which have not been observed (e.g., may or not be true values).

In some embodiments, the observation matrix 312 is a data structure that characterizes one or more aspects of a training dataset 302. In some examples, the observation matrix 312 may indicate whether a particular entity-feature value pair 310 has been observed. For example, the observation matrix 312 may be indicative of a subset of unobserved entity-feature values and/or a subset of observed entity-feature values from the training dataset 302. By way of example, an observation matrix 312 may include a binary indicator matrix, O, which specifies whether a feature has been observed. The matrix, O, may include the same dimensions as the training dataset 302, X. An observation value, Oᵢⱼ, of the observation matrix 312, O, may include a “1” (e.g., an indication of an observed entity-feature value) in the event that a respective entity-feature value pair 310 has been measured via a previous data collection operation. An observation value, Oᵢⱼ, of the observation matrix 312, O, may include a “0” (e.g., an indication of an unobserved entity-feature value) in the event that a respective entity-feature value pair has not been measured via a previous data collection operation. By way of example, in a clinical prediction domain, if patient i has been measured for hypertension (e.g., with a blood pressure cuff), O_{i, hypertension}=1 and if patient i has not been measured for hypertension, O_{i, hypertension}=0.

When combined, the observation matrix 312 and the true value matrix may result in the training dataset 302. For instance, X=Z⊙O, where ⊙ is the element-wise multiplication operator. In a clinical prediction domain, for example, for hypertension to be present in the EHR (X_{i, hypertension}=1), the patient must actually be hypertensive (Z_{i, hypertension}=1) and the patient must have been measured for hypertension (O_{i, hypertension}=1). If the patient does not have hypertension (Z_{i,hypertension}=0) or has not been measured for hypertension (O_{i, hypertension}=0), hypertension will be absent from the EHR (X_{i, hypertension}=0).

In some embodiments, the techniques of the present disclosure leverage the observation matrix 312 to prioritize data collection operations for unobserved features of the training dataset 302. For example, a datapoint priority matrix 318 may be generated that corresponds to the plurality of entity-feature value pairs of the training dataset 302.

In some embodiments, the datapoint priority matrix 318 is a data structure that characterizes one or more aspects of a training dataset 302. For instance, the datapoint priority matrix 318 may include one or more values that may be correlated to one or more entity-feature value pairs of the training dataset 302. In some examples, the datapoint priority matrix 318 may be a matrix data structure with the same dimensions as the training dataset 302.

In some embodiments, the datapoint priority matrix 318 includes a plurality of datapoint value predictions 320. A datapoint value prediction 320 may be indicative of a predictive value of performing a datapoint collection operation for an entity-feature value pair 310 of the training dataset 302. By way of example, in a datapoint priority matrix 318. V, a datapoint value prediction 320, Vᵢⱼ, may be indicative of the predictive value of performing a datapoint collection operation for an entity-feature value pair 310, Xᵢⱼ, of the training dataset 302, X.

In some embodiments, the datapoint priority matrix 318. V, is initialized as a matrix of zeros corresponding to the entity-feature value pairs 310 of the training dataset 302, X. The datapoint priority matrix 318 may be refined, using some of the techniques of the present disclosure, by iteratively generating a datapoint value prediction 320 for one or more of the entity-feature value pairs 310 to generate a refined datapoint priority matrix. In some examples, each datapoint value prediction 320 may be based on an impact prediction 304, a feature sensitivity prediction 314, and/or an entity sensitivity prediction 316 respectively generated for a particular entity-feature value pair 310. In some examples, a datapoint value prediction 320 may be generated for a subset of the entity-feature pairs based on the observation matrix 312.

A refined datapoint priority matrix may be generated by updating the datapoint priority matrix 318 based on a plurality of predictions. The predictions, for example, may include a plurality of impact predictions 304, a plurality of sensitivity predictions, and/or the like. For example, a plurality of impact predictions 304 may be generated for the plurality of entity-feature value pairs 310. An impact prediction of the plurality of impact predictions 304 may be indicative of a likelihood of a modification to an entity-feature value pair of the plurality of entity-feature value pairs 310 through one or more data collection operations. In some examples, an entity-feature value pair 310 may correspond to an entity 306 and a predictive feature of the entity 306. In such a case, the impact prediction 304 is based on at least one of (i) one or more feature-level attributes of the predictive feature and/or (ii) one or more entity-level attributes of the entity 306. In some examples, the one or more feature-level attributes are indicative of a predictive feature miss rate for the predictive feature and/or the one or more entity-level attributes are indicative of a predictive entity miss rate for the entity 306.

In some embodiments, the impact predictions 304 is a data value that describes an attribute of an entity-feature value pair 310. For example, an impact prediction 304, \hat{Δ}ᵢⱼ, may include a missingness estimation that identifies a probability that an unobserved entity-feature value pair may change in response to data collection operation. The impact prediction 304, \hat{Δ}ᵢⱼ, for example, may include an estimate of the change in value of Xᵢⱼ after a data collection operation.

In some embodiments, the impact prediction 304 for an entity-feature value pair 310 is based on a predictive feature miss rate, a predictive entity miss rate, and/or a variance associated therewith. The predictive feature miss rate may be indicative of a rate at which a particular feature is detected in response to a data collection operation. For instance, the predictive feature miss rate may include an average number of detections proportional to a total number of data collection operations for a particular feature. The predictive entity miss rate may be indicative of a rate at which any feature is detected for a particular entity (and/or entity type) in response to data collection operations. For instance, the predictive entity miss rate may include an average number of detections proportional to a total number of data collection operations for a particular entity (and/or entity type). An entity type, for example, may be indicative of a cohort of entities with one or more similar attributes.

In some examples, an impact prediction 304, \hat{Δ}ᵢⱼ, may be the maximum number of cases in which an entity who currently lacks an observed feature is assigned the observed feature after a data collection operation. By way of example, in a clinical prediction domain, the impact prediction 304, \hat{Δ}ᵢⱼ, may be the maximum number of cases in which patients who currently lack a given diagnosis in their EHR could have that diagnosis added if tested. The maximum number of feature changes (e.g., diagnostic switches) from negative to positive may be equal to the number of instances in which an entity (e.g., patient) actually exhibits a feature, Zᵢⱼ=1, minus the number of instances in which the feature is reported in the medical record, Xᵢⱼ=1. In some examples, it may be assumed that there are no false positives in which an entity does not actually exhibit the feature, was tested, and received a positive test result. The impact prediction 304, Δᵢⱼ, may be generated using a Beta distribution and an initial “guess” of the missingness of feature j by an average feature miss rate, μⱼ, and variance, σⱼ². In a continuous learning embodiment, the feature miss rate and/or entity miss rate may be continuously updated as more data is collected according to a Beta-Binomial conjugate.

As one example, in an offline setting, a subroutine for computing \hat{Δ}ᵢⱼ may include:

$${α}_{j} = ( \frac{1 - {μ}_{j}}{{σ}_{j}^{2}} - \frac{1}{{μ}_{j}} ) {μ}_{j}^{2} , {β}_{j} = {α}_{j} ( \frac{1}{{μ}_{j}} - 1 ) ∀ j ∈ [ K ]$$

$${\hat{Δ}}_{i j} ∼ B e t a ( {α}_{j} , {β}_{j} )$$

In some embodiments, in the absence of domain-informed miss rates, αⱼ=βⱼ=1.

As another example, in a continuous learning setting, a subroutine for computing \hat{Δ}ᵢⱼ may include:

$$If t = 0 :$$

$${α}_{j} = ( \frac{1 - {μ}_{j}}{{σ}_{j}^{2}} - \frac{1}{{μ}_{j}} ) {μ}_{j}^{2} , {β}_{j} = {α}_{j} ( \frac{1}{{μ}_{j}} - 1 ) ∀ j ∈ [ K ]$$

$$Return {\hat{Δ}}_{i j} ∼ B e t a ( {α}_{j} + {\sum }_{t} {r}_{j}^{t} , {β}_{j} + {\sum }_{t} ( 1 - {r}_{j}^{t} ) )$$

where the superscript t corresponds to a variable at time step t and the subscript r corresponds to a reward history. For example, X^{(t)} may correspond to X after t rounds of data collection operations. In addition, or alternatively, the reward history, r, may include a list of the data collected for each feature j. For example, if at time t, the jth feature has been collected for 5 entities, the reward history for j may look like [0, 1, 1, 0, 1], where a positive value is observed for the second, third, and fifth entity. If feature j is collected across 100 entities, and 30 of those entities yielded a positive value, then Δᵢⱼ˜ Beta(31, 71).

In some examples, the sensitivity predictions may include a plurality of feature sensitivity predictions 314 and/or entity sensitivity predictions 316. For example, a plurality of feature sensitivity predictions 314 may be generated for the plurality of entity-feature value pairs 310. A feature sensitivity prediction of the plurality of feature sensitivity predictions 314 may be indicative of a feature-level performance impact of the entity-feature value pair on the machine learning model. In addition, or alternatively, a plurality of entity sensitivity predictions 316 may be generated. An entity sensitivity prediction of the plurality of entity sensitivity predictions 316 may be indicative of an entity-level performance impact of the entity-feature value pair on the machine learning model.

In some embodiments, the feature sensitivity prediction 314 is a data value that describes an attribute of an entity-feature value pair 310. For example, a feature sensitivity prediction 314, ϕᵢⱼ, may include a feature sensitivity estimation that identifies a performance impact that a feature may have on a machine learning model. The feature sensitivity prediction 314, ϕᵢⱼ, for example, may include an estimate of the change in the performance of the machine learning model after a data collection operation for the entity-feature value pair 310, Xᵢⱼ.

In some embodiments, the entity sensitivity prediction 316 is a data value that describes an attribute of an entity-feature value pair 310. For example, an entity sensitivity prediction 316, Eᵢ, may include an entity sensitivity estimation that identifies a performance impact that an entity may have on a machine learning model. The entity sensitivity prediction 316, Eᵢ, for example, may include an estimate of the change in the performance of the machine learning model after a data collection operation for the entity-feature pairs of an Eᵢ.

For example, the entity sensitivity prediction 316 may include an estimate of a machine learning model's uncertainty for a given entity, i. For entities for which the model is currently performing more poorly, the expected benefit of a data collection operation may be greater. The entity sensitive prediction may be reflected in the predictive entropy of the model on xᵢ:

$${E}_{i} = 1 - h ( {x}_{i} ) log [ h ( {x}_{i} ) ] - ( 1 - h ( {x}_{i} ) ) log [ 1 - h ( {x}_{i} ) ]$$

The predictive entropy may be maximized when the model prediction h(xᵢ)=0.5, and may be minimized when h(xᵢ)=0 or h(xᵢ)=1.

In some embodiments, the datapoint priority matrix 318 is updated to generate a refined datapoint priority matrix based on the impact predictions 304, the feature sensitivity predictions 314, and the entity sensitivity predictions 316. For example, the refined datapoint priority matrix may include a plurality of datapoint value predictions 320. Each of the datapoint value predictions 320 may be based on an aggregation of an impact prediction 304, a feature sensitivity prediction 314, and an entity sensitivity prediction 316 for an entity-feature value pair 310 of the training dataset. In some examples, the datapoint value prediction 320 may include the product of the impact prediction 304, the feature sensitivity prediction 314, and the entity sensitivity prediction 316.

In some examples, the refined datapoint priority matrix may be generated based on the observation matrix 312. For example, the refined datapoint priority matrix may be generated by iteratively generating the plurality of impact predictions 304, the plurality of feature sensitivity predictions 314, and the plurality of entity sensitivity predictions 316 based on the observation matrix 312. By way of example, the refined datapoint priority matrix may be generated according to the below operations:

$$Initialize V = matrix of zeros like X$$

$$For i in N :$$

$$If {O}_{ji} = 1 ;$$

$$Continue$$

$${\hat{Δ}}_{ij} \sim Beta ( {α}_{j} , {β}_{j} )$$

$${ϕ}_{ij} = \frac{1}{\vert {G}_{i} \vert !} {\sum }_{S ∈ {π}_{{G}_{i} \backslash j}} [ {f}_{i} ( S ⋃ j ) - {f}_{i} ( S ) ]$$

$${E}_{i} = 1 - h ( {x}_{i} ) log [ h ( {x}_{i} ) ] - ( 1 - h ( {x}_{i} ) ) log [ 1 - h ( {x}_{i} ) ]$$

$${V}_{ij} = {\hat{Δ}}_{ij} \times {ϕ}_{ij} \times {E}_{i}$$

$$return KNAPSACK ( V , B , C )$$

The operations may begin by initializing the datapoint priority matrix 318, V, with the estimate of the value for each datapoint of training dataset 302, X. Then, the operations include iterating through entity-feature value pairs. For each entity-feature value pair, the operations may skip if it has already been observed. Otherwise, the operations compute a datapoint value prediction 320, Vᵢⱼ, according to the formula Vᵢⱼ=\hat{Δ}ᵢⱼ×ϕᵢⱼ×E(xᵢ). Lastly, a combinatoric optimization model 328, such as KNAPSACK, is leveraged to generate a data collection output 324.

In some embodiments, a data collection output 324 for the training dataset 302 is provided based on the refined datapoint priority matrix, a data augmentation threshold 326, and/or a cost matrix 322. The data collection output 324 may be indicative of a data collection operation for observing one or more unobserved values of the training dataset 302. For example, the data collection output 324 may include a list of datapoints to collect given a fixed data augmentation threshold (e.g., budget, etc.). In some examples, the data collection output 324 may include a cost curve, where the x-axis is indicative of a portion of the data augmentation threshold 326 (e.g., of a budget required) and/or the y-axis is a predicted improvement to the machine learning model's performance. In such a case, the techniques of the present disclosure may allow users to reason through tradeoffs between data augmentation criteria (e.g., a budget constraints, etc.) and model performance before setting the data augmentation threshold 326.

In some embodiments, the data collection output 324 is indicative of one or more data collection operations. A data collection operation may be an action configured to augment the training dataset 302 with one or more observed values. A datapoint collection operation may include a computing task and/or manual operation. By way of example, a datapoint collection operation may include computing tasks for querying previously unobserved datapoints from a data source, transforming data to generate a previously unobserved datapoint, generating and/or providing one or more instructions for initiating a data collection task, and/or the like. As other examples, the datapoint collection operation may include manual operations, such as performing one or more diagnostic actions (e.g., in a clinical prediction domain, etc.), and/or the like.

In some examples, a datapoint collection operation may correspond to an entity-feature value pair 310 of the training dataset 302. For instance, a data collection operation may be configured to receive an observed value for a particular entity-feature value pair 310. By way of example, in a clinical prediction domain, a datapoint collection operation may include a diagnostic test (e.g., through one or more computing and/or manual operations, etc.) for diagnosing a particular feature for a patient. In some examples, a datapoint collection operation may be configured to collect a plurality of observed feature values for a plurality of different entity-feature value pairs.

In some embodiments, the refined datapoint priority matrix includes a plurality of datapoint value predictions 320 corresponding to a plurality of entity-feature value pairs 310 of the training dataset 302. In some examples, the data collection output 324 may be based on a cost matrix 322 characterizing a cost for each of the datapoint value prediction 320. For instance, a cost matrix 322 may be received that includes a plurality of cost values corresponding to the plurality of entity-feature value pairs 310.

In some embodiments, the cost matrix 322 is a data structure that characterizes one or more aspects of a training dataset 302. In some examples, the cost matrix 322 may indicate a cost associated with one or more data collection operations for a particular entity-feature value pair 310. For instance, the cost matrix 322 may include one or more values that may be correlated to one or more entity-feature value pairs of the training dataset 302. In some examples, the cost matrix 322 may be a matrix data structure with the same dimensions as the training dataset 302. In such a case, the cost matrix 322 may indicate a cost for each entity-feature value pair 310 of the training dataset 302. By way of example, the cost matrix 322, C, may include a matrix of cost values, where the cost value, Cᵢⱼ, may correspond to the cost of collecting the jth feature for the ith entity. In some examples, the cost may vary for each entity 306, feature 308, and/or entity-feature value pair 310. In addition, or alternatively, the cost may include a fixed cost for one or more entities 306, features 308, and/or entity-feature value pairs 310.

In some examples, the data augmentation threshold 326 may be indicative of a limit on the one or more data collection operations. The data augmentation threshold 326 may be received through user input, dynamically determined based on model performance criteria, and/or the like. In some examples, the data collection output 324 may be generated, using a combinatoric optimization model 328, based on the refined datapoint priority matrix, the cost matrix 322, and the data augmentation threshold 326.

In some embodiments, the data augmentation threshold 326 is a data entity that describes a constraint for determining a set of data collection operations. The data augmentation threshold, for example, may be indicative of a limit on the one or more data collection operations. For instance, the data augmentation threshold may include a budget, B, for performing the one or more data collection operations. The data augmentation threshold. B, may include a scalar value. It may be preset, dynamically set, and/or automatically determined based on one or more data collection policies associated with the training dataset 302, machine learning model, and/or an organization.

In some embodiments, the combinatoric optimization model 328 is a data entity that describes parameters, hyper-parameters, and/or defined operations of a rules-based and/or machine learning model (e.g., model including at least one of one or more rule-based layers, one or more layers that depend on trained parameters, coefficients, and/or the like). The combinatoric optimization model 328 may include any type of model configured, trained, and/or the like to optimize a set of options based on one or more constraints, such as the data augmentation threshold 326. For example, the combinatoric optimization model 328 may include a knapsack algorithm and/or any other optimization method, for determining one or more data collection operations for a training dataset 302.

For instance, the combinatoric optimization model 328 may be configured to generate one or more data collection operations based on a data augmentation threshold 326, a list of entity-feature value pairs (e.g., from the datapoint priority matrix 318, etc.), and/or one or costs (e.g., from the cost matrix 322). The one or more data collection operations may include operations for which the sum total value is maximized under the constraint that the sum total cost is less than the data augmentation threshold 326, B. For example:

$$max {\sum }_{i = 1}^{N} {\sum }_{j = 1}^{K} {V}_{ij} {O}_{ij}$$

$$subject to {\sum }_{i = 1}^{N} {\sum }_{j = 1}^{K} {C}_{ij} {O}_{ij} \leq B$$

In some examples, a 0/1 knapsack algorithm may be used to handle cases in which 0 or 1 copies of each item may be chosen. In a clinical prediction domain, using the values for \hat{Δ}ᵢⱼ, ϕᵢⱼ, and E, the 0/1 knapsack algorithm may output a list of patient-by-feature combinations (i, j) in order of decreasing predictive value (V). Each combination may be associated with the cost of testing the patient for the particular feature. The list may be truncated when the sum of the costs exceeds data augmentation threshold 326, B.

In some embodiments, some of the techniques of the present disclosure are iteratively applied in an online setting to incrementally refine the training dataset 302. For example, collection feedback data 330 may be received based on the performance of one or more data collection operations.

In some embodiments, the collection feedback data 330 is an output from one or more datapoint collection operations. The collection feedback data 330, for example, may include a plurality of observed values for one or more entity-feature value pairs 310 of the training dataset 302.

In some examples, the collection feedback data 330 may be leveraged to update one or more attributes of the training dataset 302, the entities 306, and/or features 308 of the training dataset 302, and/or one or more corresponding matrices described herein. By way of example, the collection feedback data 330 may be leveraged to update the subset of unobserved entity-feature values of the observation matrix 312. As another example, the collection feedback data 330 may be leveraged to update at least one of the predictive feature miss rate and/or the predictive entity miss rate. In some examples, some of the techniques of the present disclosure may be continuously repeated for one or more iterations based on the updated values. In some examples, the techniques of the present disclosure may be implemented in an online setting and may be repeated during one or more predetermined time periods and/or may be triggered in response to an event, such as a performance event in which the machine learning model's performance drops below a threshold.

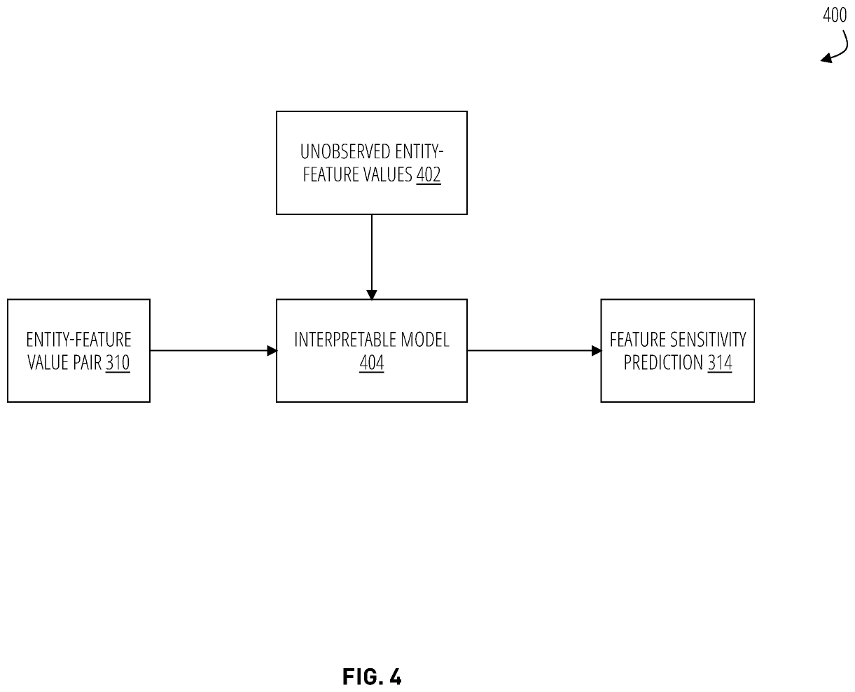

As described herein, a plurality of predictions may be predictive of an impact to a machine learning model's performance. In some examples, one or more of the predictions may be generated using interpretable models for understanding a feature's impact on model performance. For instance, the feature sensitivity prediction 314 may include a machine learning feature prediction which will now further be described with reference to FIG. 4.

FIG. 4 provides a dataflow diagram 400 of a machine learning feature sensitivity prediction technique for interpreting feature impact on model performance in accordance with some embodiments discussed herein. In some examples, a feature sensitivity prediction 314 may be generated for an entity-feature value pair 310 using an interpretable model 404 and an indication of unobserved entity-feature values 402 of a training dataset. For instance, the subset of unobserved entity-feature values 402 may be identified from the plurality of entity-feature value pairs. A plurality of feature sensitivity predictions may be generated based on the subset of unobserved entity-feature values 402 such that the feature-level performance impact of the entity-feature value pair 310 is indicative of marginal performance contribution of a predictive feature relative to the subset of unobserved entity-feature values 402 rather than the training dataset 302 as a whole.

In some embodiments, the feature sensitivity prediction 314, ϕᵢⱼ, is indicative of an estimate of the change in a model's performance that assumes a data collection operation will change a feature value from 0 to 1. The feature sensitivity prediction 314 may be generated using an interpretable model 404. For instance, a modified version of a Shapley value may be leveraged to generate a feature sensitivity prediction 314, ϕᵢⱼ, to estimate how the predictive performance of a model will change. Unlike traditional machine learning interpretation techniques, the feature sensitivity prediction 314, ϕᵢⱼ, evaluates an average marginal contribution of a feature across permutations of a subset (e.g., rather than all) of features (e.g., a subset of unobserved features) that could potentially change through one or more data collection operations. For example, a subroutine for computing ϕᵢⱼ may include:

$${ϕ}_{i j} = \frac{1}{\vert {G}_{i} \vert !} {\sum }_{S ∈ {π}_{{G}_{i} \backslash j}} [ {f}_{i} ( S ⋃ j ) - {f}_{i} ( S ) ]$$

In the equation above, Gᵢ={j:Oᵢⱼ=0} may represent a subset of unobserved entity-feature values 402 (e.g., a set of indices for all features which have not been observed) and π_{G} may be the set of all permutations of those indices. The term ƒᵢ may represent a function that maps a set of indices S to the model's prediction on a perturbed version of xᵢ where xᵢⱼ=1∀j∈S. In this manner, the feature sensitivity prediction 314 may be indicative of an average marginal change in model prediction over all permutations that xᵢ can take on over the course of one or more data collection operations.

In some embodiments, the interpretable model 404 is a data entity that describes parameters, hyper-parameters, and/or defined operations of a rules-based and/or machine learning model (e.g., model including at least one of one or more rule-based layers, one or more layers that depend on trained parameters, coefficients, and/or the like). The interpretable model 404 may include any type of model configured, trained, and/or the like to interpret an output of a machine learning model. For example, the interpretable model may include one or more explainable AI methods (“xAI”) configured to explain an output of a machine learning model. In some examples, the interpretable model may include a Shapley Additive explanations algorithm (“SHAP”), explainable graph neural network (“XGNN”), Local Interpretable Model Agnostic Explanations (“LIME”), and/or the like.

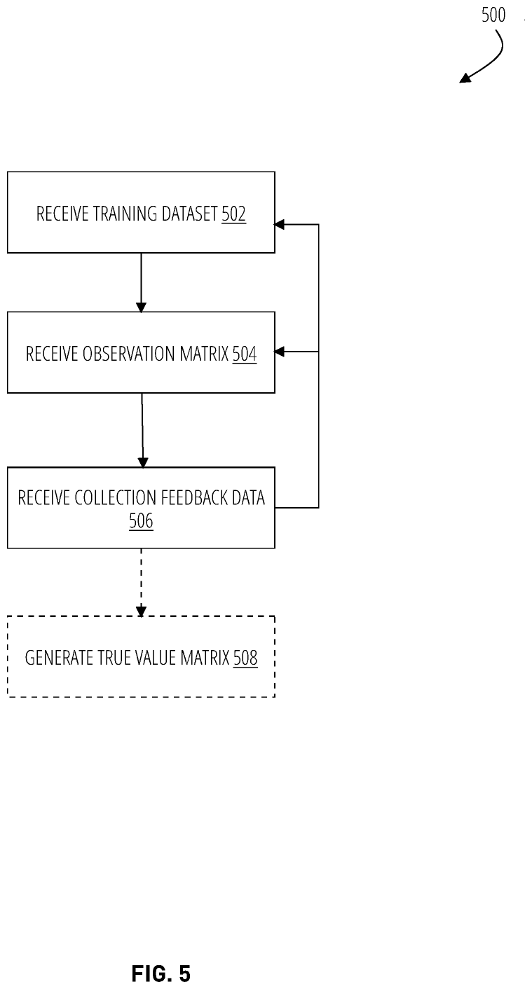

FIG. 5 is a flowchart showing an example of a process 500 for augmenting a training dataset in accordance with some embodiments discussed herein. The flowchart depicts an iterative data augmentation technique for refining a training dataset to overcome various limitations of traditional model training and data augmentation techniques. The data augmentation techniques may be implemented by one or more computing devices, entities, and/or systems described herein. For example, via the various steps/operations of the process 500, the computing system 100 may leverage the data augmentation techniques to overcome the various limitations with traditional techniques by leveraging an observation matrix and a plurality of predictions tailored to the training dataset to optimally receive collection feedback data that is tailored to the training dataset and one or more data collection constraints.

FIG. 5 illustrates an example process 500 for explanatory purposes. Although the example process 500 depicts a particular sequence of steps/operations, the sequence may be altered without departing from the scope of the present disclosure. For example, some of the steps/operations depicted may be performed in parallel or in a different sequence that does not materially impact the function of the process 500. In other examples, different components of an example device or system that implements the process 500 may perform functions at substantially the same time or in a specific sequence.

In some embodiments, the process 500 includes, at step/operation 502, receiving a training dataset. For example, the computing system 100 may receive the training dataset. The training dataset may include a plurality of entity-feature pairs indicative of the presence and/or absence of a respective feature for one or more entities.

In some embodiments, the process 500 includes, at step/operation 504, receiving an observation matrix. For example, the computing system 100 may receive the observation matrix. The observation matrix may be indicative of a subset of unobserved entity-feature values and/or a subset of observed entity-feature values from the training dataset.

In some embodiments, the process 500 includes, at step/operation 506, receiving collection feedback data. For example, the computing system 100 may receive the collection feedback data. The collection feedback data may include one or more observed values for the training dataset. In some examples, the collection feedback data may be received based on the performance of one or more data collection operations that are tailored, using the techniques of the present disclosure, to the training dataset to optimize the performance of a machine learning model with respect to a data augmentation threshold. The collection feedback data may be leveraged to update the training dataset, the observation matrix, and/or one or more aspects of the training dataset, such a predictive feature miss rate and/or a predictive entity miss rate for a predictive feature or entity of the training dataset. In this manner, some of the techniques of the present disclosure may continuously adapt to a current state of a training dataset. Moreover, unlike traditional data augmentation techniques, some of the techniques of the present disclosure may iteratively update the training dataset based on a model performance, while remaining within one or more data collection constraints. This allows a training dataset to be dynamically updated over time based on constraints of a user, regardless of the complexity and/or size of the training dataset. In this manner, the process 500 may be practically applied in any machine learning use case to optimally improve training data, thereby resulting in technical improvements to machine learning models.

In some embodiments, the process 500 includes, at step/operation 508, generating a true value matrix. For example, the computing system 100 may augment the training dataset to generate the true value matrix and/or a portion of the true value matrix. The collection feedback data, for example, may include one or more observed values for replacing unobserved values of the true value matrix. In some examples, the process 500 may be continuously executed to incrementally refine the training dataset with one or more values until a true value matrix is achieved.

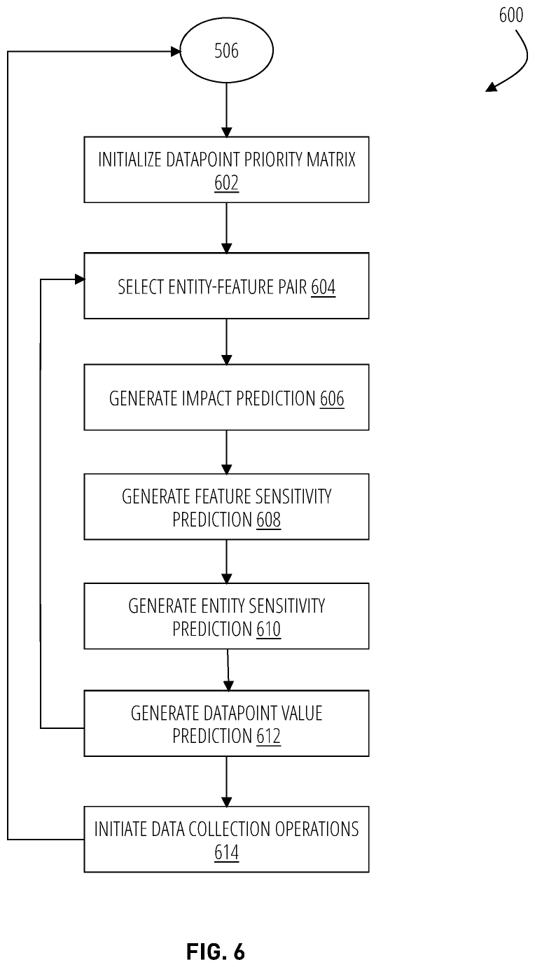

FIG. 6 is a flowchart showing an example of a process 600 for optimizing one or more data collection operations for a training dataset in accordance with some embodiments discussed herein. The flowchart depicts a multistage prediction technique for initiating data collection operations that are tailored to a machine learning model to overcome various limitations of traditional model training techniques. The multistage prediction techniques may be implemented by one or more computing devices, entities, and/or systems described herein. For example, via the various steps/operations of the process 600, the computing system 100 may leverage the multistage prediction techniques to overcome the various limitations with traditional techniques by aggregating a plurality of feature and entity specific predictions tailored to one or more aspects of a training dataset and machine learning model trained using the training dataset.

FIG. 6 illustrates an example process 600 for explanatory purposes. Although the example process 600 depicts a particular sequence of steps/operations, the sequence may be altered without departing from the scope of the present disclosure. For example, some of the steps/operations depicted may be performed in parallel or in a different sequence that does not materially impact the function of the process 600. In other examples, different components of an example device or system that implements the process 600 may perform functions at substantially the same time or in a specific sequence.

In some embodiments, the process 600 includes, at step/operation 602, initializing a datapoint priority matrix. For example, the computing system 100 may initialize the datapoint priority matrix. For instance, the computing system 100 may generate a datapoint priority matrix that corresponds to a plurality of entity-feature value pairs of a training dataset for a machine learning model.

In some embodiments, the process 600 includes, at step/operation 604, selecting an entity-feature value pair from the training dataset. For example, the computing system 100 may select an entity-feature value pair from the training dataset. The entity-feature value pair, for example, may include an unobserved entity-feature value from the training dataset. In some examples, some of the step/operations of the process 600 may be performed for each unobserved entity-feature value of the training dataset.

In some embodiments, the process 600 includes, at step/operation 606, generating an impact prediction. For example, the computing system 100 may generate the impact prediction. For instance, the computing system 100 may generate a plurality of impact predictions for the plurality of entity-feature value pairs of the training dataset. An impact prediction of the plurality of impact predictions may be indicative of a likelihood of a modification to an entity-feature value pair of the plurality of entity-feature value pairs through one or more data collection operations.

For example, the entity-feature value pair may correspond to an entity and a predictive feature of the entity. The impact prediction may be based on at least one of (i) one or more feature-level attributes of the predictive feature or (ii) one or more entity-level attributes of the entity. In some examples, the one or more feature-level attributes may be indicative of a predictive feature miss rate for the predictive feature and/or the one or more entity-level attributes may be indicative of a predictive entity miss rate for the entity.

In some embodiments, the process 600 includes, at step/operation 608, generating a feature sensitivity prediction. For example, the computing system 100 may generate the feature sensitivity prediction. For instance, the computing system 100 may generate a plurality of feature sensitivity predictions for the plurality of entity-feature value pairs of the training dataset. A feature sensitivity prediction of the plurality of feature sensitivity predictions may be indicative of a feature-level performance impact of the entity-feature value pair on the machine learning model. In some examples, the computing system 100 may identify a subset of unobserved entity-feature values from the plurality of entity-feature value pairs (e.g., based on the observation matrix, etc.). The computing system 100 may generate, using an interpretable model, the plurality of feature sensitivity predictions based on the subset of unobserved entity-feature values. For example, the feature-level performance impact of the entity-feature value pair may be indicative of marginal performance contribution of a predictive feature relative to the subset of unobserved entity-feature values.

In some embodiments, the process 600 includes, at step/operation 610, generating an entity sensitivity prediction. For example, the computing system 100 may generate the entity sensitivity prediction. For instance, the computing system 100 may generate a plurality of entity sensitivity predictions. An entity sensitivity prediction of the plurality of entity sensitivity predictions may be indicative of an entity-level performance impact of the entity-feature value pair on the machine learning model.

In some embodiments, the process 600 includes, at step/operation 612, generating a datapoint value prediction. For example, the computing system 100 may generate the datapoint value prediction. In some examples, the computing system 100 may generate a refined datapoint priority matrix, including the datapoint value prediction, by updating the datapoint priority matrix based on the plurality of impact predictions and the plurality of sensitivity predictions. For example, the refined datapoint priority matrix may include a datapoint value prediction that is based on an aggregation of the impact prediction, the feature sensitivity prediction, and the entity sensitivity prediction.

In some examples, the step/operations 604 through 612 may be performed for each unobserved entity-feature value of the training dataset to refine the datapoint priority matrix. For instance, the refined datapoint priority matrix may include a plurality of datapoint value predictions corresponding to the plurality of entity-feature value pairs of the training dataset. By way of example, the computing system 100 may iteratively generate the plurality of impact predictions, the plurality of feature sensitivity predictions, and/or the plurality of entity sensitivity predictions based on the observation matrix.

In some embodiments, the process 600 includes, at step/operation 614, initiating one or more data collection operations. For example, the computing system 100 may initiate the one or more data collection operations. For instance, the computing system 100 may provide a datapoint collection output for the training dataset based on the refined datapoint priority matrix and a data augmentation threshold, The datapoint collection output may be indicative of a data collection operation of the one or more data collection operations. The process 600 may include initiating the data collection operation identified by the datapoint collection output.

In some examples, the computing system 100 may receive a cost matrix that includes a plurality of cost values corresponding to the plurality of entity-feature value pairs of the training dataset. In addition, or alternatively, the computing system 100 may receive a data augmentation threshold that is indicative of a limit on the one or more data collection operations. The computing system 100 may generate, using a combinatoric optimization model, the data collection output based on the refined datapoint priority matrix, the cost matrix, and the data augmentation threshold.

In some examples, the process 600 may include a subset of operations for receiving collection feedback data in accordance with step/operation 506 of the process 500. For instance, the process 600 may be continuously performed in an online and/or offline setting to incrementally augment a training dataset based on the predictive performance of a machine learning model.

Some techniques of the present disclosure enable the generation of action outputs that may be performed to initiate one or more predictive actions to achieve real-world effects. The machine learning techniques of the present disclosure may be used, applied, and/or otherwise leveraged to generate impact predictions, feature sensitivity predictions, entity sensitivity predictions, collection feedback data, and/or the like. These outputs may be leveraged to initiate the performance of various computing tasks that improve the performance of a computing system (e.g., a computer itself, etc.) with respect to various predictive actions performed by the computing system 100.

In some examples, the computing tasks may include predictive actions that may be based on a prediction domain. A prediction domain may include any environment in which computing systems may be applied to achieve real-word insights, such as predictions, and initiate the performance of computing tasks, such as predictive actions, to act on the real-world insights. These predictive actions may cause real-world changes, for example, by controlling a hardware component, providing targeted data collection operations, data quality alerts, automatically allocating computing or human resources, and/or the like.

Examples of prediction domains may include financial systems, clinical systems, autonomous systems, robotic systems, and/or the like. Predictive actions in such domains may include the initiation of automated instructions across and between devices, automated notifications, automated scheduling operations, automated precautionary actions, automated security actions, automated data processing actions, automated server load balancing actions, automated computing resource allocation actions, automated adjustments to computing and/or human resource management, and/or the like.

As one example, a prediction domain may include a clinical prediction domain. In such a case, the predictive actions may include automated physician notification actions, automated patient notification actions, automated appointment scheduling actions, automated prescription recommendation actions, automated drug prescription generation actions, automated implementation of precautionary actions, automated record updating actions, automated datastore updating actions, automated hospital preparation actions, automated workforce management operational management actions, automated server load balancing actions, automated resource allocation actions, automated call center preparation actions, automated hospital preparation actions, automated pricing actions, automated plan update actions, automated alert generation actions, and/or the like.

In some embodiments, the multistage prediction techniques of process 600 are applied to initiate the performance of one or more predictive actions. As described herein, the predictive actions may depend on the prediction domain. In some examples, the computing system 100 may leverage the multistage prediction techniques to generate a data collection output that may be leveraged to initiate data collection operations, such as diagnostic tests, and/or the like, for augmenting a training dataset. These predictive insights may be leveraged to refine a machine learning model to improve model performance over time. Moreover, the data collection outputs may be displayed as visual renderings of the aforementioned examples to illustrate data quality and data augmentation options for improving data quality given constraints of a particular organization.

### VI. Conclusion

Many modifications and other embodiments will come to mind to one skilled in the art to which the present disclosure pertains having the benefit of the teachings presented in the foregoing descriptions and the associated drawings. Therefore, it is to be understood that the present disclosure is not to be limited to the specific embodiments disclosed and that modifications and other embodiments are intended to be included within the scope of the appended claims. Although specific terms are employed herein, they are used in a generic and descriptive sense only and not for purposes of limitation.

### VII. Examples

Example 1. A computer-implemented method, the computer-implemented method comprising generating, by one or more processors, a datapoint priority matrix that corresponds to a plurality of entity-feature value pairs of a training dataset for a machine learning model; generating, by the one or more processors, a plurality of impact predictions for the plurality of entity-feature value pairs, wherein an impact prediction of the plurality of impact predictions is indicative of a likelihood of a modification to an entity-feature value pair of the plurality of entity-feature value pairs through one or more data collection operations; generating, by the one or more processors, a plurality of feature sensitivity predictions for the plurality of entity-feature value pairs, wherein a feature sensitivity prediction of the plurality of feature sensitivity predictions is indicative of a feature-level performance impact of the entity-feature value pair on the machine learning model; generating, by the one or more processors, a refined datapoint priority matrix by updating the datapoint priority matrix based on the plurality of impact predictions and the plurality of sensitivity predictions; and providing, by the one or more processors, a datapoint collection output for the training dataset based on the refined datapoint priority matrix and a data augmentation threshold, wherein the datapoint collection output is indicative of a data collection operation of the one or more data collection operations.

Example 2. The computer-implemented method of example 1, wherein the entity-feature value pair corresponds to an entity and a predictive feature of the entity, and wherein the impact prediction is based on at least one of (i) one or more feature-level attributes of the predictive feature or (ii) one or more entity-level attributes of the entity.

Example 3. The computer-implemented method of example 2, wherein the one or more feature-level attributes are indicative of a predictive feature miss rate for the predictive feature and the one or more entity-level attributes are indicative of a predictive entity miss rate for the entity.

Example 4. The computer-implemented method of example 3 further comprising receiving collection feedback data based on the performance of the data collection operation; and updating at least one of the predictive feature miss rate or the predictive entity miss rate based on the collection feedback data.

Example 5. The computer-implemented method of any of the preceding examples further comprising generating a plurality of entity sensitivity predictions, wherein an entity sensitivity prediction of the plurality of entity sensitivity predictions is indicative of an entity-level performance impact of the entity-feature value pair on the machine learning model; and generating the refined datapoint priority matrix based on the plurality of entity sensitivity predictions.

Example 6. The computer-implemented method of example 5, wherein generating the datapoint priority matrix comprises receiving an observation matrix for the training dataset, wherein the observation matrix is indicative of a subset of unobserved entity-feature value and a subset of observed entity-feature values from the training dataset; and iteratively generating the plurality of impact predictions, the plurality of feature sensitivity predictions, and the plurality of entity sensitivity predictions based on the observation matrix.

Example 7. The computer-implemented method of examples 5 or 6, wherein the refined datapoint priority matrix comprises a datapoint value prediction that is based on an aggregation of the impact prediction, the feature sensitivity prediction, and the entity sensitivity prediction.

Example 8. The computer-implemented method of any of the preceding examples, wherein the refined datapoint priority matrix comprises a plurality of datapoint value predictions corresponding to the plurality of entity-feature value pairs of the training dataset, and the data collection output is generated by receiving a cost matrix that comprises a plurality of cost values corresponding to the plurality of entity-feature value pairs; receiving the data augmentation threshold indicative of a limit on the one or more data collection operations; and generating, using a combinatoric optimization model, the data collection output based on the refined datapoint priority matrix, the cost matrix, and the data augmentation threshold.

Example 9. The computer-implemented method of any of the preceding examples, wherein generating the plurality of feature sensitivity predictions comprises identifying a subset of unobserved entity-feature values from the plurality of entity-feature value pairs; and generating, using an interpretable model, the plurality of feature sensitivity predictions based on the subset of unobserved entity-feature values, wherein the feature-level performance impact of the entity-feature value pair is indicative of marginal performance contribution of a predictive feature relative to the subset of unobserved entity-feature values.

Example 10. The computer-implemented method of example 9 further comprising receiving collection feedback data based on the performance of the data collection operation; and updating the subset of unobserved entity-feature values based on the collection feedback data.

Example 11. A computing system comprising memory and one or more processors communicatively coupled to the memory, the one or more processors configured to generate a datapoint priority matrix that corresponds to a plurality of entity-feature value pairs of a training dataset for a machine learning model; generate a plurality of impact predictions for the plurality of entity-feature value pairs, wherein an impact prediction of the plurality of impact predictions is indicative of a likelihood of a modification to an entity-feature value pair of the plurality of entity-feature value pairs through one or more data collection operations; generate a plurality of feature sensitivity predictions for the plurality of entity-feature value pairs, wherein a feature sensitivity prediction of the plurality of feature sensitivity predictions is indicative of a feature-level performance impact of the entity-feature value pair on the machine learning model; generate a refined datapoint priority matrix by updating the datapoint priority matrix based on the plurality of impact predictions and the plurality of sensitivity predictions; and provide a datapoint collection output for the training dataset based on the refined datapoint priority matrix and a data augmentation threshold, wherein the datapoint collection output is indicative of a data collection operation of the one or more data collection operations.

Example 12. The computing system of example 11, wherein the entity-feature value pair corresponds to an entity and a predictive feature of the entity, and wherein the impact prediction is based on at least one of (i) one or more feature-level attributes of the predictive feature or (ii) one or more entity-level attributes of the entity.

Example 13. The computing system of example 12, wherein the one or more feature-level attributes are indicative of a predictive feature miss rate for the predictive feature and the one or more entity-level attributes are indicative of a predictive entity miss rate for the entity.

Example 14. The computing system of any of examples 11 through 13, wherein the one or more processors are further configured to generate a plurality of entity sensitivity predictions, wherein an entity sensitivity prediction of the plurality of entity sensitivity predictions is indicative of an entity-level performance impact of the entity-feature value pair on the machine learning model; and generate the refined datapoint priority matrix based on the plurality of entity sensitivity predictions.

Example 15. The computing system of example 14, wherein generating the datapoint priority matrix comprises receiving an observation matrix for the training dataset, wherein the observation matrix is indicative of a subset of unobserved entity-feature value and a subset of observed entity-feature values from the training dataset; and iteratively generating the plurality of impact predictions, the plurality of feature sensitivity predictions, and the plurality of entity sensitivity predictions based on the observation matrix.

Example 16. The computing system of example 14, wherein the refined datapoint priority matrix comprises a datapoint value prediction that is based on an aggregation of the impact prediction, the feature sensitivity prediction, and the entity sensitivity prediction.

Example 17. The computing system of any of examples 11 through 16, wherein the refined datapoint priority matrix comprises a plurality of datapoint value predictions corresponding to the plurality of entity-feature value pairs of the training dataset, and the data collection output is generated by receiving a cost matrix that comprises a plurality of cost values corresponding to the plurality of entity-feature value pairs; receiving the data augmentation threshold indicative of a limit on the one or more data collection operations; and generating, using a combinatoric optimization model, the data collection output based on the refined datapoint priority matrix, the cost matrix, and the data augmentation threshold.

Example 18. One or more non-transitory computer-readable storage media including instructions that, when executed by one or more processors, cause the one or more processors to: generate a datapoint priority matrix that corresponds to a plurality of entity-feature value pairs of a training dataset for a machine learning model; generate a plurality of impact predictions for the plurality of entity-feature value pairs, wherein an impact prediction of the plurality of impact predictions is indicative of a likelihood of a modification to an entity-feature value pair of the plurality of entity-feature value pairs through one or more data collection operations; generate a plurality of feature sensitivity predictions for the plurality of entity-feature value pairs, wherein a feature sensitivity prediction of the plurality of feature sensitivity predictions is indicative of a feature-level performance impact of the entity-feature value pair on the machine learning model; generate a refined datapoint priority matrix by updating the datapoint priority matrix based on the plurality of impact predictions and the plurality of sensitivity predictions; and provide a datapoint collection output for the training dataset based on the refined datapoint priority matrix and a data augmentation threshold, wherein the datapoint collection output is indicative of a data collection operation of the one or more data collection operations.

Example 19. The one or more non-transitory computer-readable storage media of example 18, wherein generating the plurality of feature sensitivity predictions comprises: identifying a subset of unobserved entity-feature values from the plurality of entity-feature value pairs; and generating, using an interpretable model, the plurality of feature sensitivity predictions based on the subset of unobserved entity-feature values, wherein the feature-level performance impact of the entity-feature value pair is indicative of marginal performance contribution of a predictive feature relative to the subset of unobserved entity-feature values.

Example 20. The one or more non-transitory computer-readable storage media of example 19, wherein the one or more processors are further caused to receive collection feedback data based on the performance of the data collection operation; and update the subset of unobserved entity-feature values based on the collection feedback data.

1. A computer-implemented method, the computer-implemented method comprising:
generating, by one or more processors, a datapoint priority matrix that corresponds to a plurality of entity-feature value pairs of a training dataset for a machine learning model;
generating, by the one or more processors, a plurality of impact predictions for the plurality of entity-feature value pairs, wherein an impact prediction of the plurality of impact predictions is indicative of a likelihood of a modification to an entity-feature value pair of the plurality of entity-feature value pairs through one or more data collection operations;
generating, by the one or more processors, a plurality of feature sensitivity predictions for the plurality of entity-feature value pairs, wherein a feature sensitivity prediction of the plurality of feature sensitivity predictions is indicative of a feature-level performance impact of the entity-feature value pair on the machine learning model;
generating, by the one or more processors, a refined datapoint priority matrix by updating the datapoint priority matrix based on the plurality of impact predictions and the plurality of feature sensitivity predictions; and
providing, by the one or more processors, a datapoint collection output for the training dataset based on the refined datapoint priority matrix and a data augmentation threshold, wherein the datapoint collection output is indicative of a data collection operation of the one or more data collection operations.

2. The computer-implemented method of claim 1, wherein the entity-feature value pair corresponds to an entity and a predictive feature of the entity, and wherein the impact prediction is based on at least one of (i) one or more feature-level attributes of the predictive feature or (ii) one or more entity-level attributes of the entity.

3. The computer-implemented method of claim 2, wherein the one or more feature-level attributes are indicative of a predictive feature miss rate for the predictive feature and the one or more entity-level attributes are indicative of a predictive entity miss rate for the entity.

4. The computer-implemented method of claim 3 further comprising:
receiving collection feedback data based on the performance of the data collection operation; and
updating at least one of the predictive feature miss rate or the predictive entity miss rate based on the collection feedback data.

5. The computer-implemented method of claim 1 further comprising:
generating a plurality of entity sensitivity predictions, wherein an entity sensitivity prediction of the plurality of entity sensitivity predictions is indicative of an entity-level performance impact of the entity-feature value pair on the machine learning model; and
generating the refined datapoint priority matrix based on the plurality of entity sensitivity predictions.

6. The computer-implemented method of claim 5, wherein generating the datapoint priority matrix comprises:
receiving an observation matrix for the training dataset, wherein the observation matrix is indicative of a subset of unobserved entity-feature value and a subset of observed entity-feature values from the training dataset; and
iteratively generating the plurality of impact predictions, the plurality of feature sensitivity predictions, and the plurality of entity sensitivity predictions based on the observation matrix.

7. The computer-implemented method of claim 5, wherein the refined datapoint priority matrix comprises a datapoint value prediction that is based on an aggregation of the impact prediction, the feature sensitivity prediction, and the entity sensitivity prediction.

8. The computer-implemented method of claim 1, wherein the refined datapoint priority matrix comprises a plurality of datapoint value predictions corresponding to the plurality of entity-feature value pairs of the training dataset, and the data collection output is generated by:
receiving a cost matrix that comprises a plurality of cost values corresponding to the plurality of entity-feature value pairs;
receiving the data augmentation threshold indicative of a limit on the one or more data collection operations; and
generating, using a combinatoric optimization model, the data collection output based on the refined datapoint priority matrix, the cost matrix, and the data augmentation threshold.

9. The computer-implemented method of claim 1, wherein generating the plurality of feature sensitivity predictions comprises:
identifying a subset of unobserved entity-feature values from the plurality of entity-feature value pairs; and
generating, using an interpretable model, the plurality of feature sensitivity predictions based on the subset of unobserved entity-feature values, wherein the feature-level performance impact of the entity-feature value pair is indicative of marginal performance contribution of a predictive feature relative to the subset of unobserved entity-feature values.

10. The computer-implemented method of claim 9 further comprising:
receiving collection feedback data based on the performance of the data collection operation; and
updating the subset of unobserved entity-feature values based on the collection feedback data.

11. A computing system comprising memory and one or more processors communicatively coupled to the memory, the one or more processors configured to:
generate a datapoint priority matrix that corresponds to a plurality of entity-feature value pairs of a training dataset for a machine learning model;
generate a plurality of impact predictions for the plurality of entity-feature value pairs, wherein an impact prediction of the plurality of impact predictions is indicative of a likelihood of a modification to an entity-feature value pair of the plurality of entity-feature value pairs through one or more data collection operations;
generate a plurality of feature sensitivity predictions for the plurality of entity-feature value pairs, wherein a feature sensitivity prediction of the plurality of feature sensitivity predictions is indicative of a feature-level performance impact of the entity-feature value pair on the machine learning model;
generate a refined datapoint priority matrix by updating the datapoint priority matrix based on the plurality of impact predictions and the plurality of feature sensitivity predictions; and
provide a datapoint collection output for the training dataset based on the refined datapoint priority matrix and a data augmentation threshold, wherein the datapoint collection output is indicative of a data collection operation of the one or more data collection operations.

12. The computing system of claim 11, wherein the entity-feature value pair corresponds to an entity and a predictive feature of the entity, and wherein the impact prediction is based on at least one of (i) one or more feature-level attributes of the predictive feature or (ii) one or more entity-level attributes of the entity.

13. The computing system of claim 12, wherein the one or more feature-level attributes are indicative of a predictive feature miss rate for the predictive feature and the one or more entity-level attributes are indicative of a predictive entity miss rate for the entity.

14. The computing system of claim 11, wherein the one or more processors are further configured to:
generate a plurality of entity sensitivity predictions, wherein an entity sensitivity prediction of the plurality of entity sensitivity predictions is indicative of an entity-level performance impact of the entity-feature value pair on the machine learning model; and
generate the refined datapoint priority matrix based on the plurality of entity sensitivity predictions.

15. The computing system of claim 14, wherein generating the datapoint priority matrix comprises:
receiving an observation matrix for the training dataset, wherein the observation matrix is indicative of a subset of unobserved entity-feature value and a subset of observed entity-feature values from the training dataset; and
iteratively generating the plurality of impact predictions, the plurality of feature sensitivity predictions, and the plurality of entity sensitivity predictions based on the observation matrix.

16. The computing system of claim 14, wherein the refined datapoint priority matrix comprises a datapoint value prediction that is based on an aggregation of the impact prediction, the feature sensitivity prediction, and the entity sensitivity prediction.

17. The computing system of claim 11, wherein the refined datapoint priority matrix comprises a plurality of datapoint value predictions corresponding to the plurality of entity-feature value pairs of the training dataset, and the data collection output is generated by:
receiving a cost matrix that comprises a plurality of cost values corresponding to the plurality of entity-feature value pairs;
receiving the data augmentation threshold indicative of a limit on the one or more data collection operations; and
generating, using a combinatoric optimization model, the data collection output based on the refined datapoint priority matrix, the cost matrix, and the data augmentation threshold.

18. One or more non-transitory computer-readable storage media including instructions that, when executed by one or more processors, cause the one or more processors to:
generate a datapoint priority matrix that corresponds to a plurality of entity-feature value pairs of a training dataset for a machine learning model;
generate a plurality of impact predictions for the plurality of entity-feature value pairs, wherein an impact prediction of the plurality of impact predictions is indicative of a likelihood of a modification to an entity-feature value pair of the plurality of entity-feature value pairs through one or more data collection operations;
generate a plurality of feature sensitivity predictions for the plurality of entity-feature value pairs, wherein a feature sensitivity prediction of the plurality of feature sensitivity predictions is indicative of a feature-level performance impact of the entity-feature value pair on the machine learning model;
generate a refined datapoint priority matrix by updating the datapoint priority matrix based on the plurality of impact predictions and the plurality of feature sensitivity predictions; and
provide a datapoint collection output for the training dataset based on the refined datapoint priority matrix and a data augmentation threshold, wherein the datapoint collection output is indicative of a data collection operation of the one or more data collection operations.

19. The one or more non-transitory computer-readable storage media of claim 18, wherein generating the plurality of feature sensitivity predictions comprises:
identifying a subset of unobserved entity-feature values from the plurality of entity-feature value pairs; and
generating, using an interpretable model, the plurality of feature sensitivity predictions based on the subset of unobserved entity-feature values, wherein the feature-level performance impact of the entity-feature value pair is indicative of marginal performance contribution of a predictive feature relative to the subset of unobserved entity-feature values.

20. The one or more non-transitory computer-readable storage media of claim 19, wherein the one or more processors are further caused to:
receive collection feedback data based on the performance of the data collection operation; and
update the subset of unobserved entity-feature values based on the collection feedback data.
